(19) United States
(12) Patent Application Publication
(10) Pub. No.: US 2026/0209406 A1
(43) Pub. Date: Jul. 23, 2026

(54) COMPOSITION CONTAINING FLUORINE-CONTAINING POLYMER AND APROTIC SOLVENT, FLUORINE-CONTAINING POLYMER, METHOD FOR PRODUCING FLUORINE-CONTAINING POLYMER SOLUTION, METHOD FOR PRODUCING MIXTURE OF FLUORINE MONOMER AND APROTIC SOLVENT, AND METHOD FOR PRODUCING FLUORINE-CONTAINING POLYMER

(71) Applicant: DAIKIN INDUSTRIES, LTD., Osaka (JP)

(72) Inventors: Daichi MARI, Osaka (JP); Noriyuki SHINOKI, Osaka (JP); Tadashi INO, Osaka (JP)

(73) Assignee: DAIKIN INDUSTRIES, LTD., Osaka (JP)

(21) Appl. No.: 19/442,197

(22) Filed: Jan. 7, 2026

Related U.S. Application Data
(63) Continuation of application No. PCT/JP2024/024819, filed on Jul. 9, 2024.

(30) Foreign Application Priority Data
Jul. 11, 2023 (JP) 2023-114062

(51) Int. Cl. C08F 124/00

(52) U.S. Cl. CPC C08F 124/00

(57) ABSTRACT

An object of the present disclosure is to provide, for example, a method for producing a fluorine-containing polymer in which the generation of fluoride ions during polymerization is suppressed.

The present disclosure relates to the following composition:
a composition comprising a fluorine-containing polymer (A) and an aprotic solvent (B),
the composition comprising fluoride ions in an amount of 0.01 to 500 ppm by mass,
the fluorine-containing polymer (A) comprising a structural unit represented by formula (A1), a structural unit represented by formula (A2), or a structural unit represented by formula (A3) as a main component,
the aprotic solvent (B) being at least one solvent selected from the group consisting of a perfluoroaromatic compound, a perfluorotrialkylamine, a perfluoroalkane, a hydrofluorocarbon, a fluorocyclic ether, a hydrofluoroether, and an olefin compound containing at least one chlorine atom.

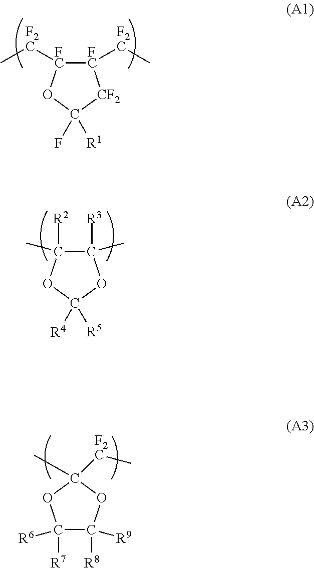

### TECHNICAL FIELD

The present disclosure relates to a composition that comprises a fluorine-containing polymer and an aprotic solvent and that has a low fluoride ion content, methods for producing a fluorine-containing polymer and a fluorine-containing polymer solution, a method for producing a mixture of a fluorine-containing polymer and an aprotic solvent, a method for producing a fluorine-containing polymer, and the like.

### BACKGROUND ART

A fluorine-containing polymer containing a structural unit having a cyclic structure is produced by polymerizing a fluorine-containing monomer having a cyclic structure containing an etheric oxygen atom as a ring-constituting element. For example, Patent Literature (PTL) 1 discloses a method for producing a fluororesin, comprising a precipitation polymerization step of performing precipitation polymerization in the presence of a monomer, a radical polymerization initiator, and an organic solvent, with a water content in the reaction system of 1000 ppm by mass or less.

### CITATION LIST

### Patent Literature

PTL 1: JP2020-122068A

### SUMMARY

The present disclosure includes, for example, the following embodiments.

A composition comprising a fluorine-containing polymer (A) and an aprotic solvent (B),
the composition comprising fluoride ions in an amount of 0.01 to 500 ppm by mass,
the fluorine-containing polymer (A) comprising, as a main component, a structural unit represented by formula (A1):

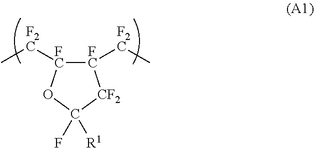

wherein R¹ represents a fluorine atom, a C₁-C₅ perfluoroalkyl group, or a C₁-C₅ perfluoroalkoxy group,
a structural unit represented by formula (A2):

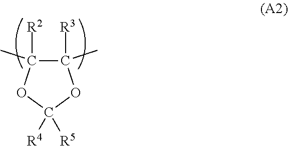

wherein R² to R⁵ each independently represent a fluorine atom, a C₁-C₅ perfluoroalkyl group, or a C₁-C₅ perfluoroalkoxy group, or
a structural unit represented by formula (A3):

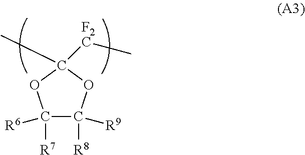

wherein R⁶ to R⁹ each independently represent a fluorine atom, a C₁-C₅ perfluoroalkyl group, or a C₁-C₅ perfluoroalkoxy group, and
the aprotic solvent (B) being at least one solvent selected from the group consisting of a perfluoroaromatic compound, a perfluorotrialkylamine, a perfluoroalkane, a hydrofluorocarbon, a fluorocyclic ether, a hydrofluoroether, and an olefin compound containing at least one chlorine atom.

### Advantageous Effects

The present disclosure provides a method for producing a fluorine-containing polymer in which the generation of fluoride ions during polymerization is suppressed, a composition comprising a fluorine-containing polymer and an aprotic solvent and having a low fluoride ion content, and the like, all of which can suppress corrosion of production equipment caused by fluoride ions and suppress increases in waste liquid treatment costs.

### DESCRIPTION OF EMBODIMENTS

The above overview of the present disclosure is not intended to describe each of the disclosed embodiments or all of the implementations of the present disclosure.

The following description of the present disclosure more specifically provides examples of illustrative embodiments.

Guidance is provided through examples in several parts of the present disclosure, and these examples can be used in various combinations.

In each case, the group of examples can function as a non-exclusive and representative group.

All publications, patents, and patent applications cited herein are incorporated herein by reference in their entirety.

### Terms

Unless otherwise specified, the symbols and abbreviations in the present specification can be understood in the context of the present specification in the meanings commonly used in the technical field to which the present disclosure belongs.

In the present specification, the terms “comprise” and “contain” are used with the intention of including the phrases “consisting essentially of” and “consisting of.”

Unless otherwise specified, the steps, treatments, or operations described in the present specification may be performed at room temperature. In the present specification, room temperature can refer to a temperature within the range of 10 to 40° C.

In the present specification, the phrase “Cₙ-Cₘ” (n and m are each a number) indicates that the number of carbon atoms is n or more and m or less, as a person skilled in the art would generally understand.

In the present specification, the description of compounds can include all stereoisomers (enantiomers, diastereomers, geometric isomers, etc.) unless otherwise specified by a person skilled in the art.

In the present specification, unless otherwise specified, the “alkyl group” includes linear, branched, and cyclic alkyl groups. The alkyl group may be a linear or branched alkyl group.

The number of carbon atoms in the alkyl group may be, for example, 1 to 12, 1 to 6, 1 to 5, 1 to 4, 1 to 3, 6, 5, 4, 3, 2, or 1.

Examples of alkyl groups include linear or branched alkyl groups, such as methyl, ethyl, propyl (e.g., n-propyl and isopropyl), butyl (e.g., n-butyl, isobutyl, sec-butyl, and tert-butyl), pentyl (e.g., n-pentyl, tert-pentyl, neopentyl, isopentyl, sec-pentyl, and 3-pentyl), hexyl, heptyl, octyl, nonyl, decyl, undecyl, and dodecyl; and cyclic alkyl groups, such as cyclopropyl, cyclobutyl, cyclopentyl, cyclohexyl, cycloheptyl, and cyclooctyl.

In the present specification, unless otherwise specified, the “fluoroalkyl group” includes a linear, branched, or cyclic alkyl group in which at least one hydrogen atom is replaced by a fluorine atom. The fluoroalkyl group may be a linear or branched fluoroalkyl group.

The number of carbon atoms in the fluoroalkyl group may be, for example, 1 to 12, 1 to 6, 1 to 5, 1 to 4, 1 to 3, 6, 5, 4, 3, 2, or 1.

The number of fluorine atoms in the fluoroalkyl group may be one or more (e.g., 1 to 3, 1 to 5, 1 to 9, 1 to 11, or 1 to the maximum substitutable number).

The fluoroalkyl group includes a perfluoroalkyl group. The perfluoroalkyl group is an alkyl group in which all of the hydrogen atoms are replaced by fluorine atoms.

Examples of fluoroalkyl groups include linear or branched C₁-C₂₀ fluoroalkyl groups (for example, C₁-C₁₀, C₁-C₄, and C₁-C₃, preferably C₁-C₇, more preferably C₁-C₆ fluoroalkyl groups) (preferably perfluoroalkyl groups), such as methyl having 1 to 3 fluorine atoms, ethyl having 1 to 5 fluorine atoms, propyl (e.g., n-propyl and isopropyl) having 1 to 7 fluorine atoms, butyl (e.g., n-butyl, isobutyl, sec-butyl, and tert-butyl) having 1 to 9 fluorine atoms, pentyl (e.g., n-pentyl, tert-pentyl, neopentyl, isopentyl, sec-pentyl, and 3-pentyl) having 1 to 11 fluorine atoms, hexyl having 1 to 13 fluorine atoms, heptyl having 1 to 15 fluorine atoms, octyl having 1 to 17 fluorine atoms, nonyl having 1 to 19 fluorine atoms, decyl having 1 to 21 fluorine atoms, undecyl having 1 to 23 fluorine atoms, dodecyl having 1 to 25 fluorine atoms, tridecyl having 1 to 27 fluorine atoms, tetradecyl having 1 to 29 fluorine atoms, pentadecyl having 1 to 31 fluorine atoms, hexadecyl having 1 to 33 fluorine atoms, heptadecyl having 1 to 35 fluorine atoms, octadecyl having 1 to 37 fluorine atoms, nonadecyl having 1 to 39 fluorine atoms, and icosyl having 1 to 41 fluorine atoms; and cyclic C₃-C₁₀ fluoroalkyl groups (e.g., C₃-C₆, C₄-C₆, C₃-C₅, C₅-C₆, and C₄-C₈ fluoroalkyl groups) (preferably perfluoroalkyl groups), such as cyclofluoropropyl, cyclofluorobutyl, cyclofluoropentyl, cyclofluorohexyl, cyclofluoroheptyl, cyclofluorooctyl, and fluoroadamantyl.

Examples of perfluoroalkyl groups include trifluoromethyl (CF₃—), pentafluoroethyl (C₂F₅—), perfluoropropyl (e.g., CF₃CF₂CF₂— and (CF₃)₂CF—), perfluorobutyl (e.g., CF₃CF₂CF₂CF₂—, (CF₃)₂CFCF₂—, (CF₃CF(CF₃)CF₂—, and (CF₃)₃C—), perfluoropentyl (e.g., CF₃CF₂CF₂CF₂CF₂—, (CF₃)₂CFCF₂CF₂—, CF₃CF₂CF(CF₃)CF₂—, CF₃CF₂CF₂CF(CF₃)—, and CF₃C(CF₃)₂CF₂—), and the like.

Specific examples of fluoroalkyl groups include the perfluoroalkyl groups listed above, a monofluoromethyl group, a difluoromethyl group, a 2,2,2-trifluoroethyl group (CF₃CH₂—), a tetrafluoropropyl group (e.g., HCF₂CF₂CH₂—), a hexafluoropropyl group (e.g., (CF₃)₂CH—), an octafluoropentyl group (e.g., HCF₂CF₂CF₂CF₂CH₂—), and the like.

In the present specification, unless otherwise specified, the “alkoxy group” may be a group represented by RO—, wherein R is an alkyl group. The alkoxy group includes linear, branched, and cyclic alkoxy groups. The alkoxy group may be a linear or branched alkoxy group.

The number of carbon atoms in the alkoxy group may be, for example, 1 to 12, 1 to 6, 1 to 5, 1 to 4, 1 to 3, 6, 5, 4, 3, 2, or 1.

Examples of alkoxy groups include linear or branched alkoxy groups, such as methoxy, ethoxy, propoxy, isopropoxy, butoxy, isobutoxy, sec-butoxy, tert-butoxy, pentyloxy, isopentyloxy, neopentyloxy, hexyloxy, heptyloxy, octyloxy, nonyloxy, and decyloxy; and cyclic alkoxy groups, such as cyclopropyloxy, cyclobutyloxy, cyclopentyloxy, cyclohexyloxy, cycloheptyloxy, and cyclooctyloxy.

In the present specification, unless otherwise specified, the “fluoroalkoxy group” is an alkoxy group in which at least one hydrogen atom is replaced by a fluorine atom. The “fluoroalkoxy group” may be a linear or branched fluoroalkoxy group.

The number of carbon atoms in the fluoroalkoxy group may be, for example, 1 to 12, 1 to 6, 1 to 5, 1 to 4, 1 to 3, 6, 5, 4, 3, 2, or 1.

The number of fluorine atoms in the fluoroalkoxy group may be one or more (e.g., 1 to 3, 1 to 5, 1 to 9, 1 to 11, or 1 to the maximum substitutable number).

The fluoroalkoxy group includes a perfluoroalkoxy group.

The perfluoroalkoxy group is an alkoxy group in which all of the hydrogen atoms are replaced by fluorine atoms.

Examples of perfluoroalkoxy groups include trifluoromethyloxy (CF₃O—), pentafluoroethyloxy (C₂F₅O—), perfluoropropyloxy (e.g., CF₃CF₂CF₂O— and (CF₃)₂CFO—), perfluorobutyloxy (e.g., CF₃CF₂CF₂CF₂O—, (CF₃)₂CFCF₂O—, (CF₃CF(CF₃)CF₂O—, and (CF₃)₃CO—), perfluoropentyloxy (e.g., CF₃CF₂CF₂CF₂CF₂O—, (CF₃)₂CFCF₂CF₂O—, CF₃CF₂CF(CF₃)CF₂O—, CF₃CF₂CF₂CF(CF₃)O—, and CF₃C(CF₃)₂CF₂O—), and the like.

Specific examples of fluoroalkoxy groups include the perfluoroalkoxy groups listed above, monofluoromethoxy, difluoromethoxy, 2,2,2-trifluoroethyloxy (CF₃CH₂O—), tetrafluoropropyloxy (e.g., HCF₂CF₂CH₂O—), hexafluoropropyloxy (e.g., (CF₃)₂CHO—), octafluoropentyloxy (e.g., HCF₂CF₂CF₂CF₂CH₂O—), and the like.

### Composition

An embodiment of the present disclosure is a composition comprising (A) a fluorine-containing polymer comprising, as a main component, a structural unit represented by formula (A1), (A2), or (A3), and (B) an aprotic solvent. Despite containing the fluorine-containing polymer (A), the composition has a low fluoride ion content, which is, for example, 0.01 to 500 ppm by mass. The composition of the present disclosure can be used as a coating liquid of the fluorine-containing polymer (A), and due to its low fluoride ion content, the composition is useful in that when the coating liquid is applied to a substrate made of glass, metal, or the like to form a coating of the fluorine-containing polymer (A), corrosion and deterioration of the substrate can be suppressed. The composition of the present disclosure is also useful in that it facilitates the use of containers made of glass, metal, or the like as storage containers when storing the composition.

The composition of the present disclosure may contain other components such as a polymerization initiator and impurities that are mixed in the polymerization process of a fluorine-containing monomer (A).

### Fluorine-Containing Polymer (A)

The fluorine-containing polymer (A) comprises, as a main component, a structural unit represented by the following formula (A1), (A2), or (A3).

A structural unit represented by formula (A1) (which may be referred to as “structural unit (A1)” in the present specification):

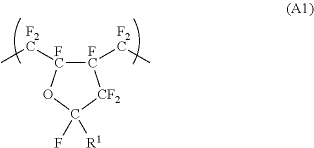

wherein R¹ represents a fluorine atom, a C₁-C₅ perfluoroalkyl group, or a C₁-C₅ perfluoroalkoxy group.

A structural unit represented by formula (A2) (which may be referred to as “structural unit (A2)” in the present specification):

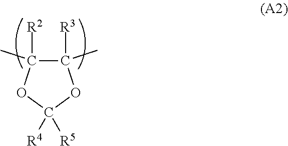

wherein R² to R⁵ each independently represent a fluorine atom, a C₁-C₅ perfluoroalkyl group, or a C₁-C₅ perfluoroalkoxy group.

A structural unit represented by formula (A3) (which may be referred to as “structural unit (A3)” in the present specification):

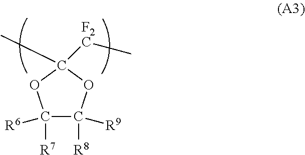

wherein R⁶ to R⁹ each independently represent a fluorine atom, a C₁-C₅ perfluoroalkyl group, or a C₁-C₅ perfluoroalkoxy group.

The phrase “comprises, as a main component, a structural unit” means that the proportion of this structural unit in all of the structural units in the fluorine-containing polymer (A) is 50 mol % or more. The proportion of the structural unit may be 51 mol % or more, 60 mol % or more, or the like, preferably 80 mol % or more, more preferably 90 mol % or more, and particularly preferably 100 mol %. The fluorine-containing polymer (A) includes a homopolymer of a structural unit represented by formula (A1), (A2), or (A3).

The structural unit represented by formula (A1), (A2), or (A3) in the fluorine-containing polymer (A) may be one or more types, preferably one to three types, more preferably one or two types, and particularly preferably one type.

In the structural unit (A1), R¹ may be a fluorine atom or a C₁-C₄ linear or branched perfluoroalkyl group. R¹ is preferably a fluorine atom, trifluoromethyl, or perfluoroethyl, more preferably a fluorine atom or trifluoromethyl, and particularly preferably a fluorine atom.

Preferred examples of the structural unit (A1) include a structural unit represented by the following formula (A1-1) (which may be referred to as “structural unit (A1-1)” in the present specification).

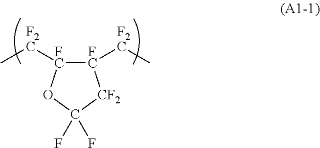

In the structural unit (A2), R² to R⁵ may be each independently a fluorine atom, a C₁-C₃ linear or branched perfluoroalkyl group, or a C₁-C₃ linear or branched perfluoroalkoxy group. R² to R⁵ are preferably each independently a fluorine atom, trifluoromethyl, pentafluoroethyl, or trifluoromethoxy, and more preferably a fluorine atom, trifluoromethyl, or trifluoromethoxy.

The structural unit (A2) is preferably a structural unit of formula (A2), wherein R² and R³ each independently represent a fluorine atom, trifluoromethyl, or trifluoromethoxy, and R⁴ and R⁵ each independently represent a fluorine atom or trifluoromethyl.

The structural unit (A2) is more preferably a structural unit of formula (A2), wherein R² represents a fluorine atom, R³ represents a fluorine atom, trifluoromethyl, or trifluoromethoxy, and R⁴ and R⁵ each independently represent a fluorine atom or trifluoromethyl.

The structural unit (A2) is particularly preferably a structural unit of formula (A2), wherein R² represents a fluorine atom, R³ represents a fluorine atom or trifluoromethoxy, and R⁴ and R⁵ are the same and represent fluorine atoms or trifluoromethyl.

Preferred examples of the structural unit (A2) include structural units represented by the following formulas (A2-1) and (A2-2) (which may be referred to as “structural unit (A2-1)” and “structural unit (A2-2),” respectively, in the present specification).

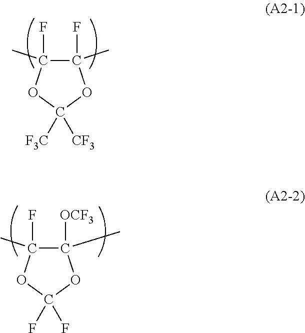

In the structural unit (A3), R⁶ to R⁹ may be each independently a fluorine atom, a C₁-C₃ linear or branched perfluoroalkyl group, or a C₁-C₃ linear or branched perfluoroalkoxy group. R⁶ to R⁹ are preferably each independently a fluorine atom, trifluoromethyl, perfluoroethyl, or trifluoromethoxy, and more preferably a fluorine atom, trifluoromethyl, or trifluoromethoxy.

The structural unit (A3) is preferably a structural unit of formula (A3), wherein R⁶ to R⁹ each independently represent a fluorine atom or trifluoromethyl.

The structural unit (A3) is more preferably a structural unit of formula (A3),
wherein R⁶ to R⁹ represent fluorine atoms;
R⁶ to R⁸ represent fluorine atoms, and R⁹ represents trifluoromethyl;
R⁶ represents trifluoromethyl, and R⁷ to R⁹ represent fluorine atoms; or
R⁶ and R⁹ represent trifluoromethyl, and R⁷ and R⁸ represent fluorine atoms.

Preferred examples of the structural unit (A3) include structural units represented by the following formulas (A3-1) and (A3-2) (which may be referred to as “structural unit (A3-1)” and “structural unit (A3-2),” respectively, in the present specification).

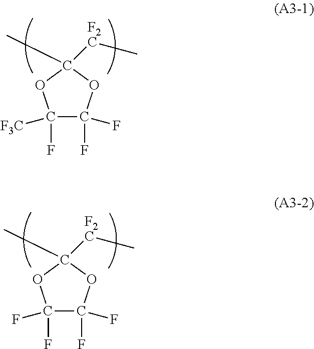

The fluorine-containing polymer (A) may comprise other structural units in addition to the structural unit (A1), (A2), or (A3) contained as the main component. The proportion of the other structural units in all of the structural units in the fluorine-containing polymer (A) may be 50 mol % or less, preferably 20 mol % or less, more preferably 10 mol % or less, and particularly preferably 0 mol %.

Examples of the other structural units include, but are not limited to, a structural unit represented by the following formula (A11) (which may be referred to as “structural unit (A11)” in the present specification):

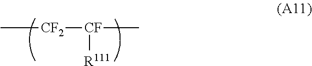

wherein R¹¹¹ represents a fluorine atom, a C₁-C₆ perfluoroalkyl group, or a C₁-C₆ perfluoroalkoxy group.

For example, the fluorine-containing polymer (A) may contain the structural unit (A2-1) and a structural unit represented by the following formula (A11-1) (which may be referred to as “structural unit (A11-1)” in the present specification):

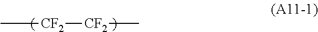

R¹¹¹ may be a fluorine atom, a linear or branched C₁-C₆ perfluoroalkyl group, or a linear or branched C₁-C₆ perfluoroalkoxy group.

R¹¹¹ is preferably a fluorine atom, a linear or branched C₁-C₄ perfluoroalkyl group, or a linear or branched C₁-C₄ perfluoroalkoxy group.

R¹¹¹ is more preferably a fluorine atom, a linear or branched C₁-C₃ perfluoroalkyl group, or a linear or branched C₁-C₃ perfluoroalkoxy group.

R¹¹¹ is particularly preferably a fluorine atom or trifluoroalkyl.

The mass average molecular weight of the fluorine-containing polymer (A) may be, for example, within the range of 5000 to 1000000, 10000 to 1000000, 10000 to 500000, or 90000 to 350000. The mass average molecular weight of the fluorine-containing polymer (A) is preferably within the range of 10000 to 750000, more preferably 40000 to 500000, and particularly preferably 70000 to 350000.

The lower limit of the mass average molecular weight of the fluorine-containing polymer (A) may be, for example, 5000 or more, preferably 10000 or more, more preferably 40000 or more, and particularly preferably 70000 or more. The upper limit of the mass average molecular weight of the fluorine-containing polymer (A) may be, for example, 1000000 or less, preferably 750000 or less, more preferably 500000 or less, and particularly preferably 350000 or less. The above upper and lower limits may be appropriately combined.

The mass average molecular weight of the fluorine-containing polymer (A) is a value determined by a gel permeation chromatography (GPC) method (in particular, the GPC method described later in the Examples).

In the composition according to the present disclosure, the content of the fluorine-containing polymer (A) may be 20 mass % or more based on the mass of the composition. The content of the fluorine-containing polymer (A) may be preferably within the range of 20 mass % to 65 mass %, more preferably greater than 20 mass % to 65 mass %, and particularly preferably greater than 20 mass % to 50 mass %, based on the mass of the composition.

In the composition of the present disclosure, the fluorine-containing polymer (A) may be or may not be dissolved in the aprotic solvent (B). When the fluorine-containing polymer (A) is dissolved, the fluorine-containing polymer (A) may be partially or entirely dissolved, and it is preferred that the entire amount of the fluorine-containing polymer (A) is dissolved. When the fluorine-containing polymer (A) is not partially or entirely dissolved, the fluorine-containing polymer (A) may be in a solid form or a semi-solid form. Examples of the semi-solid form include a gel form (a form in which the fluorine-containing polymer is swollen with the aprotic solvent (B)) and the like. In the present specification, the fluorine-containing polymer (A) in a solid form and the fluorine-containing polymer (A) in a semi-solid form may be referred to as “solid of the fluorine-containing polymer (A)” and “semi-solid of the fluorine-containing polymer (A),” respectively.

In the composition of the present disclosure, a state in which the entire amount of the fluorine-containing polymer (A) is dissolved in the aprotic solvent (B) may be referred to as “fluorine-containing polymer (A) solution.” In the composition of the present disclosure, a state in which some of or the entire amount of the fluorine-containing polymer (A) is not dissolved in the aprotic solvent (B) and is in a solid form or a semi-solid form may be referred to as “mixture of the fluorine-containing polymer (A) and the aprotic solvent (B).”

When the fluorine-containing polymer (A) is dissolved in the aprotic solvent (B), it is preferred that the entire amount of the fluorine-containing polymer (A) contained in the composition of the present disclosure is dissolved, but some of the fluorine-containing polymer (A) may be dissolved. When some of the fluorine-containing polymer (A) is dissolved in the aprotic solvent (B), the undissolved fluorine-containing polymer (A) may be in a solid form or a semi-solid form. Examples of the semi-solid form include a gel form and the like.

The fluorine-containing polymer (A) may contain fluoride ions. When the fluorine-containing polymer (A) contains fluoride ions, the concentration of the fluoride ions in the fluorine-containing polymer (A) may be, for example, 0.01 to 100 ppm by mass, preferably 0.01 to 90 ppm by mass, more preferably 0.01 to 80 ppm by mass, and even more preferably 10 to 80 ppm by mass.

The fluorine-containing polymer (A) can be synthesized by a known method. For example, the fluorine-containing polymer (A) can be synthesized by polymerizing a monomer corresponding to the structural unit of the fluorine-containing polymer. The polymerization method may be, for example, radical polymerization, bulk polymerization, solution polymerization, suspension polymerization, or emulsion polymerization. The method for producing the fluorine-containing polymer (A) according to the present disclosure is particularly preferable because the fluorine-containing polymer (A) can be dissolved in a solvent at a high concentration.

### Aprotic Solvent (B)

The composition of the present disclosure comprises an aprotic solvent (B). Compared to protic solvents, aprotic solvents have several advantages: (1) fluorine-containing polymers are highly soluble in aprotic solvents; (2) aprotic solvents, which have low viscosity, are suitable as polymerization solvents and solvents for forming fluorine-containing polymer films; and (3) aprotic solvents, which have low reactivity, are capable of suppressing unexpected side reactions.

Examples of aprotonic solvents include perfluoroaromatic compounds, perfluorotrialkylamines, perfluoroalkanes, hydrofluorocarbons, fluorocyclic ethers, hydrofluoroethers, and olefin compounds containing at least one chlorine atom. These solvents can be used singly or in a combination of two or more. The solvent is preferably at least one solvent selected from the group consisting of perfluoroalkanes, hydrofluorocarbons, and hydrofluoroethers. The solvent is more preferably at least one solvent selected from the group consisting of hydrofluorocarbons and hydrofluoroethers.

The perfluoroaromatic compound is, for example, a perfluoroaromatic compound optionally having one or more perfluoroalkyl groups. The aromatic ring of the perfluoroaromatic compound may be at least one ring selected from the group consisting of a benzene ring, a naphthalene ring, and an anthracene ring. The perfluoroaromatic compound may have one or more (e.g., one, two, or three) aromatic rings.

The perfluoroalkyl group as a substituent is, for example, linear or branched C₁-C₆, C₁-C₅, or C₁-C₄ perfluoroalkyl, preferably linear or branched C₁-C₃ perfluoroalkyl, and more preferably trifluoromethyl or pentafluoroethyl.

The number of substituents is, for example, one to four, preferably one to three, and more preferably one to two. When a plurality of substituents are present, they may be the same or different.

Examples of perfluoroaromatic compounds include perfluorobenzene, perfluorotoluene, perfluoroxylene, and perfluoronaphthalene.

Preferred examples of perfluoroaromatic compounds include perfluorobenzene and perfluorotoluene.

The perfluorotrialkylamine is, for example, an amine substituted with three linear or branched perfluoroalkyl groups. The number of carbon atoms of each perfluoroalkyl group is, for example, 1 to 10, preferably 1 to 5, and more preferably 1 to 4. The perfluoroalkyl groups may be the same or different, and are preferably the same.

Examples of perfluorotrialkylamines include perfluorotrimethylamine, perfluorotriethylamine, perfluorotripropylamine, perfluorotriisopropylamine, perfluorotributylamine, perfluorotri-sec-butylamine, perfluorotri-tert-butylamine, perfluorotripentylamine, perfluorotriisopentylamine, and perfluorotrineopentylamine.

Preferred examples of perfluorotrialkylamines include perfluorotripropylamine and perfluorotributylamine.

The perfluoroalkane is, for example, a linear, branched, or cyclic C₃-C₁₂ (preferably C₃-C₁₀, more preferably C₃-C₆) perfluoroalkane.

Examples of perfluoroalkanes include perfluoropentane, perfluoro-2-methylpentane, perfluorohexane, perfluoro-2-methylhexane, perfluoroheptane, perfluorooctane, perfluorononane, perfluorodecane, perfluorocyclohexane, perfluoro(methylcyclohexane), perfluoro(dimethylcyclohexane) (e.g., perfluoro(1,3-dimethylcyclohexane)), and perfluorodecalin.

Preferred examples of perfluoroalkanes include perfluoropentane, perfluorohexane, perfluoroheptane, and perfluorooctane.

The hydrofluorocarbon is, for example, a C₃-C₈ hydrofluorocarbon. Examples of hydrofluorocarbons include CF₃CH₂CF₂H, CF₃CH₂CF₂CH₃, CF₃CHFCHFC₂F₅, 1,1,2,2,3,3,4-heptafluorocyclopentane, CF₃CF₂CF₂CF₂CH₂CH₃, CF₃CF₂CF₂CF₂CF₂CHF₂, and CF₃CF₂CF₂CF₂CF₂CF₂CH₂CH₃.

Preferred examples of hydrofluorocarbons include CF₃CHFCHFC₂F₅, 1,1,2,2,3,3,4-heptafluorocyclopentane, CF₃CH₂CF₂H and CF₃CH₂CF₂CH₃.

The fluorocyclic ether is, for example, a fluorocyclic ether optionally having one or more fluoroalkyl groups. The ring(s) of the fluorocyclic ether may be (a) 3- to 6-membered ring(s). The ring(s) of the fluorocyclic ether may have one or more oxygen atoms as a ring-constituting atom. The ring(s) preferably has/have one or two oxygen atoms, more preferably one oxygen atom.

The fluoroalkyl group as a substituent is, for example, linear or branched C₁-C₆, C₁-C₅, or C₁-C₄ fluoroalkyl. The fluoroalkyl group is preferably linear or branched C₁-C₃ fluoroalkyl. The fluoroalkyl group is preferably a linear or branched C₁-C₃ fluoroalkyl group. The fluoroalkyl group is preferably a perfluoroalkyl group, such as a linear or branched C₁-C₆, C₁-C₅, C₁-C₄, or C₁-C₃ perfluoroalkyl group.

The fluorocyclic ether is preferably a perfluorocyclic ether. The perfluorocyclic ether may have one or more perfluoroalkyl groups. The perfluoroalkyl group is, for example, a linear or branched C₁-C₆, C₁-C₅, or C₁-C₄ perfluoroalkyl group. The fluoroalkyl group is preferably linear or branched C₁-C₃ perfluoroalkyl.

The number of substituents is, for example, one to four, preferably one to three, and more preferably one to two. When a plurality of substituents are present, they may be the same or different.

Examples of fluorocyclic ethers include perfluorotetrahydrofuran, perfluoro-5-methyltetrahydrofuran, perfluoro-5-ethyltetrahydrofuran, perfluoro-5-propyltetrahydrofuran, perfluoro-5-butyltetrahydrofuran, and perfluorotetrahydropyran.

Preferred examples of fluorocyclic ethers include perfluoro-5-ethyltetrahydrofuran and perfluoro-5-butyltetrahydrofuran.

The hydrofluoroether is, for example, a fluorine-containing ether. The hydrofluoroether preferably has a global warming potential (GWP) of 600 or less, more preferably 400 or less, and particularly preferably 300 or less. The lower limit of the global warming potential (GWP) of the hydrofluoroether may be 1 or more, or 5 or more.

Examples of hydrofluoroethers include CF₃CF₂CF₂CF₂OCH₃, CF₃CF₂CF(CF₃) OCH₃, CF₃CF(CF₃)CF₂OCH₃, CF₃CF₂CF₂CF₂OC₂H₅, CF₃CH₂OCF₂CHF₂, C₂F₅CF(OCH₃)C₃F₃, (CF₃)₂CHOCH₃, (CF₃)₂CFOCH₃, (CF₃)₂CFCF₂OCH₃, (CF₃)₂CFCF₂OCH₂CH₃, CHF₂CF₂OCH₂CF₃, CHF₂CF₂CH₂OCF₂CHF₂, CF₃CHFCF₂OCH₃, CF₃CHFCF₂OCF₃, trifluoromethyl 1,2,2,2-tetrafluoroethyl ether (HFE-227me), difluoromethyl 1,1,2,2,2-pentafluoroethyl ether (HFE-227mc), trifluoromethyl 1,1,2,2-tetrafluoroethyl ether (HFE-227pc), difluoromethyl 2,2,2-trifluoroethyl ether (HFE-245mf), 2,2-difluoroethyltrifluoromethyl ether (HFE-245pf), 1,1,2,3,3-hexafluoropropyl methyl ether (CF₃CHFCF₂OCH₃), 1,1,1,2,2-tetrafluoroethyl 2,2,2-trifluoroethyl ether (CF₃CF₂OCH₂CF₃), and 1,1,1,3,3,3-hexafluoro-2-methoxypropane ((CF₃)₂CHOCH₃).

Preferred examples of hydrofluoroethers include CF₃CF₂CF₂CF₂OCH₃, CF₃CF₂CF₂CF₂OC₂H₅, CF₃CH₂OCF₂CHF₂, C₂F₅CF(OCH₃)C₃F₇, (CF₃)₂CFCF₂OCH₃, (CF₃)₂CFCF₂OCH₂CH₃, 1,1,2,3,3-hexafluoropropyl methyl ether (CF₃CHFCF₂OCH₃), 1,1,1,2,2-tetrafluoroethyl 2,2,2-trifluoroethyl ether (CHF₂CF₂OCH₂CF₃), and 1,1,1,3,3,3-hexafluoro-2-methoxypropane ((CF₃)₂CHOCH₃).

The hydrofluoroether may be at least one member selected from the group consisting of a compound represented by the following formula (B-1), a compound represented by the following formula (B-2), a compound represented by the following formula (B-3), a compound represented by the following formula (B-4), (CF₃)₂CHOCH₃, (CF₃)₂CFOCH₃, CF₃CHFCF₂OCH₃, C₂F₃CF(OCH₃)C₃F₇, (CF₃)₂CFCF₂OCH₃, (CF₃)₂CFCF₂OCH₂CH₃, CHF₂CF₂OCH₂CF₃, and CF₃CHFCF₂OCF₃.

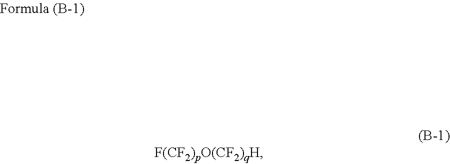

wherein p is an integer of 1 to 6, and q is an integer of 1 to 4.

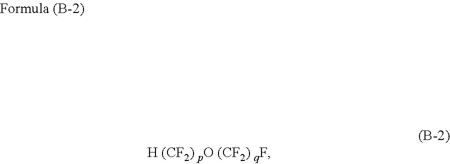

wherein p and q are as defined above.

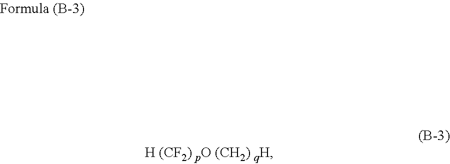

wherein p and q are as defined above.

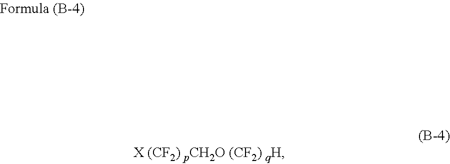

wherein X represents fluorine or hydrogen, and p and q are as defined above.

The hydrofluoroether is more preferably a compound represented by the following formula (B-5):

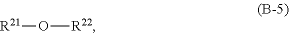

wherein R²¹ is linear or branched propyl or butyl in which at least one hydrogen atom is replaced by fluorine, and R²² is methyl or ethyl. The compound represented by formula (B-5) may be a compound in which R²¹ is perfluorobutyl, and R²² is methyl or ethyl.

The olefin compound containing at least one chlorine atom is a C₂-C₄ (preferably C₂-C₃) olefin compound containing at least one chlorine atom in its structure. The olefin compound containing at least one chlorine atom is a compound in which at least one of the hydrogen atoms bonded to the carbon atoms in a C₂-C₄ hydrocarbon having one or two double bonds (preferably one) is replaced by chlorine.

The number of chlorine atoms is one to the maximum substitutable number. The number of chlorine atoms may be, for example, one, two, three, four, or five.

The olefin compound containing at least one chlorine atom may contain at least one (e.g., one, two, three, four, or five) fluorine atom.

Examples of olefin compounds containing at least one chlorine atom include CH₂═CHCl, CHCl═CHCl, CCl₂═CHCl, CCl₂═CCl₂, CF₃CH═CHCl, CHF₂CF═CHCl, CFH₂CF═CHCl, CF₃CCl═CFCl, CF₂HCl═CFCl, and CFH₂Cl═CFCl.

Preferred examples of olefin compounds containing at least one chlorine atom include CHCl═CHCl, CHF₂CF═CHCl, CF₃CH═CHCl, and CF₃CCl═CFCl.

The aprotic solvent (B) may be at least one member selected from the group consisting of CF₃CF₂CF₂CF₂OCH₃ and (CF₃)₂CFCF₂OCH₃; hexafluorobenzene, 1,1,1,3,3,3-hexafluoro-2-methoxypropane, perfluorohexane, CF₃CH₂OCF₂CHF₂, or 1,1,2,2,3,3,4-heptafluorocyclopentane.

The aprotonic solvent (B) can be at least one member selected from the group consisting of CF₃CF₂CF₂CF₂OCH₃ and (CF₃)₂CFCF₂OCH₃; hexafluorobenzene, 1,1,1,3,3,3-hexafluoro-2-methoxypropane, or perfluorohexane.

The aprotic solvent (B) may have a global warming potential (GWP) of, for example, 600 or less, or 400 or less. The aprotic solvent (B) preferably has a global warming potential (GWP) of 375 or less, more preferably 350 or less, and particularly preferably 0. The lower limit of the global warming potential (GWP) of the aprotic solvent (B) may be 1 or more, or 5 or more.

The content of the aprotic solvent (B) in the composition of the present disclosure can be 80 mass % or less, based on the mass of the composition. The content can be preferably within the range of 35 to 80 mass %, more preferably 35 mass % to less than 80 mass %, and particularly preferably 50 mass % to less than 80 mass %, based on the mass of the composition.

The composition of the present disclosure may contain a compound represented by the following formula (C) (which may also be referred to herein as “compound (C)”). When the composition of the present disclosure contains compound (C), the content of the compound (C) can be, for example, 0.01 to 10 mass %, preferably 0.01 to 8 mass %, and more preferably 0.01 to 5 mass %, based on the total mass of the composition.

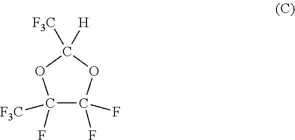 [SMILES: FC(F)(F)C1OC(F)(F)C(F)(C(F)(F)F)O1]

### Fluoride Ions

The composition of the present disclosure contains fluoride ions in addition to the fluorine-containing polymer (A) and the aprotic solvent (B). When monomers are polymerized to produce the fluorine-containing polymer (A), fluoride ions are generated, which causes disadvantages such as corrosion of manufacturing equipment and increased costs of waste liquid treatment, or requiring additional steps to remove or reduce fluoride ions. The fluoride ion concentration of the composition of the present disclosure is low, and can be, for example, 0.01 to 500 ppm by mass, which reduces the disadvantages described above. The concentration of fluoride ions in the composition of the present disclosure is preferably 0.01 to 400 ppm by mass, and more preferably 100 to 400 ppm by mass.

### Other Components

In addition to a fluorine-containing polymer (A), an aprotic solvent (B), and fluoride ions, the composition of the present disclosure may contain raw material monomers used in the production of the fluorine-containing polymer, oligomers formed from raw material monomers, polymerization initiators, impurities derived from raw materials, and the like. The amounts of these various components contained in the composition can be adjusted, for example, by setting the conditions for producing the fluorine-containing polymer (A) (e.g., temperature, time, kinds and amounts of raw material monomers, type and amount of solvent, and type and amount of polymerization initiator used). Further, the amount of each of the various components can be adjusted through purification conducted after the production of the fluorine-containing polymer (A).

### Method for Producing Fluorine-Containing Polymer (A)

The fluorine-containing polymer (A) can be produced, for example, by a polymerization step in which a monomer (M) is polymerized in a mixture of the monomer (M) and an aprotic solvent (B) (which is also referred to herein as the “raw material mixture”). For example, an aprotic solvent (B) containing a monomer (M) (either alone or a combination of the monomer (M) with one or more other monomers) and an aprotic solvent (B) optionally containing a polymerization initiator are subjected to polymerization conditions to polymerize the monomer (M), thereby producing the composition of the present disclosure. In one embodiment, the monomer (M) is polymerized in a mixture of the monomer (M) and an aprotic solvent (B) optionally with a polymerization initiator, other monomers, other components, etc. to produce the composition of the present disclosure. The polymerization method can be solution polymerization or precipitation polymerization. In solution polymerization, the entire amount of the fluorine-containing polymer (A) is dissolved in the polymerization reaction mixture. This is one embodiment of a fluorine-containing polymer (A) solution. In precipitation polymerization, either a part of the polymer remains undissolved in the polymerization reaction mixture, or the polymer is completely insoluble therein, thus obtaining a solid or semi-solid fluorine-containing polymer and a polymerization reaction mixture. This is one embodiment of a mixture of the fluorine-containing polymer (A) and the aprotic solvent (B).

The fluorine-containing polymer (A) may contain fluoride ions in a concentration of 0.01 to 100 ppm by mass, 0.05 to 100 ppm by mass, 0.05 to 90 ppm by mass, or 0.05 to 80 ppm by mass. The fluorine-containing polymer (A) preferably has a low fluoride ion content. The concentration of fluoride ions in the fluorine-containing polymer (A) is preferably 0.01 to 90 ppm by mass, more preferably 0.01 to 80 ppm by mass, and even more preferably 10 to 80 ppm by mass. In the present disclosure, the fluoride ion content of the fluorine-containing polymer (A) formed after polymerization can be reduced by using a raw material mixture with a low fluoride ion content.

In the method of producing the fluorine-containing polymer (A) of the present disclosure, a mixture of monomer (M) with a low fluoride ion content and an aprotic solvent (B) (also referred to herein as the “raw material mixture”) is used to thereby obtain a fluorine-containing polymer (A) with a low fluoride ion content. Therefore, the polymerization step in the method for producing the fluorine-containing polymer (A) of the present disclosure is preferable as a method for producing the composition of the present disclosure. The raw material mixture preferably has a fluoride ion content of 0.05 to 300 ppm by mass, more preferably 0.05 to 250 ppm by mass, even more preferably 0.05 to 200 ppm by mass, and particularly preferably 0.05 to 150 ppm by mass.

The aprotic solvent (B) may have a fluoride ion content of, for example, 100 ppm by mass or less, 50 ppm by mass or less, 25 ppm by mass or less, 10 ppm by mass or less, 5 ppm by mass or less, 1 ppm by mass or less, 0.001 to 100 ppm by mass, 0.001 to 50 ppm by mass, 0.001 to 25 ppm by mass, 0.001 to 10 ppm by mass, 0.001 to 5 ppm by mass, or 0.001 to 1 ppm by mass.

The method for reducing the fluoride ion concentration in the aprotic solvent (B) includes, for example, treatments such as adsorption, washing with water, and distillation. Activated carbon adsorption and washing with water are preferable.

### Monomers

The “monomer (M)” is a monomer corresponding to the structural unit contained as the main component in the fluorine-containing polymer (A). In addition to the monomer (M), other monomers can be used as monomers. In the present specification, monomers corresponding to structural units that are contained in the fluorine-containing polymer (A) and that are structural units other than the structural unit contained as the main component may be referred to as “other monomers.”

Those skilled in the art would be able to understand that a polymerization reaction of a specific monomer yields a fluorine-containing polymer (A) containing a structural unit corresponding to the monomer. Thus, those skilled in the art would be able to select a suitable monomer to produce the desired fluorine-containing polymer (A).

For example, the monomers corresponding to the structural unit (A1), structural unit (A2), structural unit (A3), structural unit (A1-1), structural unit (A2-1), structural unit (A2-2), structural unit (A3-1), structural unit (A3-2), and structural unit (A11-1) may be respectively monomers represented by the following formula (M1), formula (M2), formula (M3), formula (M1-1), formula (M2-1), formula (M2-2), formula (M3-1), formula (M3-2), and formula (M11-1) (which may be respectively referred to as “monomer (M1),” “monomer (M2),” “monomer (M3),” “monomer (M1-1),” “monomer (M2-1),” “monomer (M2-2),” “monomer (M3-1),” “monomer (M3-2),” and “monomer (M11-1)” in the present specification).

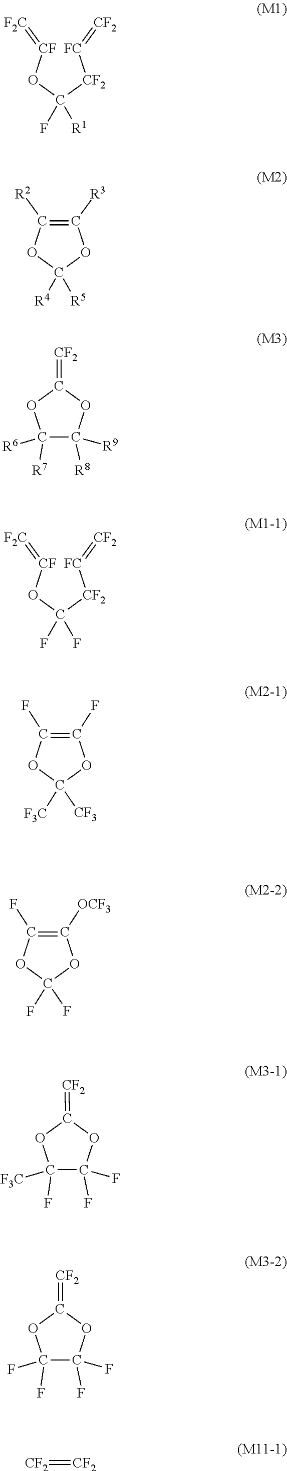

wherein R¹ to R⁹ each independently represent a fluorine atom, a C₁-C₅ perfluoroalkyl group, or a C₁-C₅ perfluoroalkoxy group.

The descriptions regarding R¹ to R⁹ in the structural units (A1), (A2), and (A3) are applicable to R¹ to R⁹ in monomers (M1), (M2), and (M3).

As the monomer (M), one monomer (M) can be used alone, or two or more monomers (M) can be used in combination. For example, a monomer (M2-1) and a monomer (M11-1) can be combined to produce a fluorine-containing polymer (A) containing structural units (A2-1) and (A11-1).

The monomer (M) may have a fluoride ion concentration of 0.01 to 1000 ppm by mass, preferably 0.01 to 800 ppm by mass, and more preferably 0.01 to 500 ppm by mass. The monomer (M) decomposes during storage, thus generating fluoride ions. As a result, fluoride ions can be mixed into the monomer (M). In the present disclosure, the fluoride ion content of the monomer (M) used in the production of the fluorine-containing polymer (A) is reduced beforehand to thereby obtain a fluorine-containing polymer (A) with a low fluoride ion concentration. Examples of the method for reducing the fluoride ion concentration in the monomer (M) include treatments such as adsorption, washing, and distillation, among which activated carbon adsorption and water washing are preferred. The distillation method is, for example, a method comprising processing the monomer (M) at a temperature of 30 to 60° C. under a pressure of 50 to 500 hPa. The adsorption method is, for example, a method comprising dissolving the monomer (M) in a solvent capable of dissolving the monomer, such as an aprotic solvent, and treating the resulting monomer solution with an adsorbent in an amount of 1 to 20 mass %, based on the mass of the monomer (M). Examples of adsorbents include activated carbon, silica gel, activated alumina, and zeolite, with activated carbon being preferable. The adsorption treatment method includes, for example, continuous flow systems and batch systems. Examples of washing with water include a method comprising dissolving the monomer (M) in a solvent capable of dissolving the monomer (M), such as an aprotic solvent (B), and then washing the resulting monomer solution with water, and a method comprising directly washing the monomer (M) with water.

The types and amounts of other monomers can be appropriately adjusted to form the desired fluorine-containing polymer (A). Examples of other monomers include those that form fluoroolefin units by polymerization (e.g., fluoroolefins). The proportion of fluoroolefin units can be 50 mol % or less, preferably 30 mol % or less, more preferably 20 mol % or less, even more preferably 10 mol % or less, and particularly preferably 0 mol %, of all of the structural units constituting the fluorine-containing polymer (A).

The fluoroolefin unit is a structural unit formed after polymerization of a monomer containing one or more fluorine atoms and carbon-carbon double bonds.

The atoms constituting the fluoroolefin unit may only be fluorine atoms, halogen atoms other than fluorine, carbon atoms, hydrogen atoms, and oxygen atoms.

The atoms constituting the fluoroolefin unit may only be fluorine atoms, halogen atoms other than fluorine, carbon atoms, and hydrogen atoms.

The atoms constituting a fluoroolefin unit may only be fluorine atoms, carbon atoms, and hydrogen atoms.

The atoms constituting a fluoroolefin unit may only be fluorine atoms and carbon atoms.

The fluoroolefin unit includes at least one unit selected from the group consisting of a fluorine-containing perhaloolefin unit, a vinylidene fluoride unit (—CH₂—CF₂—), a trifluoroethylene unit (—CFH—CF₂—), pentafluoropropylene units (—CFH—CF(CF₃)—, —CF₂—CF(CHF₂)—), a 1,1,1,2-tetrafluoro-2-propylene unit (—CH₂—CF(CF₃)—), and the like.

The fluorine-containing perhaloolefin unit is a structural unit that is formed after polymerization of a monomer containing one or more fluorine atoms and one or more carbon-carbon double bonds and that may optionally have one or more halogen atoms other than fluorine.

The fluorine-containing perhaloolefin unit includes at least one member selected from the group consisting of a chlorotrifluoroethylene unit (—CFCl—CF₂—), a tetrafluoroethylene unit (—CF₂—CF₂—), a hexafluoropropylene unit (—CF₂—CF(CF₃)—), a perfluoro(methyl vinyl ether) unit (—CF₂—CF(OCF₃)—), a perfluoro(ethyl vinyl ether) unit (—CF₂—CF(OC₂F₅)—), a perfluoro(propyl vinyl ether) unit (—CF₂—CF(OCF₂C₂F₅)—), a perfluoro(butyl vinyl ether) unit (—CF₂—CF(O(CF₂)₂C₂F₅)—), and a perfluoro(2,2-dimethyl-1,3-dioxol) unit (—CF—CAF—, wherein A represents a perfluorodioxolane ring formed with the adjacent carbon atom shown in the formula, in which two trifluoromethyl groups are bonded to the 2-position carbon of the dioxolane ring).

The fluoroolefin unit includes at least one member selected from the group consisting of a chlorotrifluoroethylene unit, a tetrafluoroethylene unit, a hexafluoropropylene unit, a perfluoro(methyl vinyl ether) unit, and a perfluoro(propyl vinyl ether) unit.

Those skilled in the art would be able to understand other monomers that correspond to structural units constituting the fluorine-containing polymer (A). Examples of monomers corresponding to tetrafluoroethylene units, hexafluoropropylene units, and vinylidene fluoride units are tetrafluoroethylene (CF₂═CF₂), hexafluoropropylene (CF₃CF═CF₂), and vinylidene fluoride (CH₂═CF₂), respectively.

The fluoroolefin (monomer) corresponding to a fluoroolefin unit may be, for example, at least one member selected from the group consisting of fluorine-containing perhaloolefin, vinylidene fluoride, trifluoroethylene, pentafluoropropylene, and 1,1,1,2-tetrafluoro-2-propylene. The fluoroolefin may preferably be at least one member selected from the group consisting of chlorotrifluoroethylene, tetrafluoroethylene, hexafluoropropylene, perfluoro(methyl vinyl ether), and perfluoro(propyl vinyl ether).

The fluorine-containing perhaloolefin may be at least one member selected from the group consisting of chlorotrifluoroethylene, tetrafluoroethylene, hexafluoropropylene, perfluoro(methyl vinyl ether), perfluoro(ethyl vinyl ether), perfluoro(propyl vinyl ether), perfluoro(butyl vinyl ether), and perfluoro(2,2-dimethyl-1,3-dioxole).

### Aprotic Solvent (B)

In the method for producing the fluorine-containing polymer (A) according to the present disclosure, the monomer is polymerized in an aprotic solvent (B). For details of the aprotic solvent (B), reference is made to the description of the aprotic solvent (B) in the composition according to the present disclosure, unless otherwise specified.

### Polymerization Initiator

In the production method of the present disclosure, a polymerization initiator may be used in the polymerization step. The polymerization initiator can be any polymerization initiator capable of polymerizing the monomer (M), and is, for example, a radical polymerization initiator. The polymerization initiator preferably contains no fluorine atoms in its structure. The polymerization initiator preferably has a 10-hour half-life temperature within the range of 0° C. to 160° C. Polymerization initiators can be used alone or in a combination of two or more.

Preferred examples of polymerization initiators that can be used in the polymerization step include di-n-propyl peroxydicarbonate, diisopropyl peroxydicarbonate, diisobutyryl peroxide, di(w-hydro-dodecafluoroheptanoyl)peroxide, di(w-hydro-hexadecafluorononanoyl)peroxide, w-hydro-dodecafluoroheptanoyl-w-hydro-hexadecafluorononanoyl-peroxide, benzoyl peroxide, bis(2,3,4,5,6-pentafluorobenzoyl) peroxide, tert-butyl peroxypivalate, tert-hexyl peroxypivalate, ammonium persulfate, sodium persulfate, and potassium persulfate.

More preferred examples of polymerization initiators include di-n-propyl peroxydicarbonate, diisopropyl peroxydicarbonate, diisobutyl peroxide, di(w-hydro-dodecafluoroheptanoyl)peroxide, benzoyl peroxide, bis(2,3,4,5,6-pentafluorobenzoyl)peroxide, tert-butyl peroxy pivalate, tert-hexyl peroxy pivalate, and ammonium persulfate.

Polymerization Step in which Monomer (M) is Polymerized

The amount of monomer (M) used in the polymerization reaction can be appropriately determined according to, for example, the proportion of the structural unit corresponding to the monomer (M) in the desired fluorine-containing polymer (A). For example, the amount of monomer (M) is 50 mol % or more, preferably 80 mol % or more, even more preferably 90 mol % or more, and particularly preferably 100 mol %, based on the total number of moles of all of the raw material monomers.

When one or more other monomers are used in addition to the monomer (M), the amount of the other monomers can be appropriately determined according to, for example, the proportion of the structural units corresponding to the other monomers in the desired fluorine-containing polymer (A). For example, the amount of the other monomers is 50 mol % or less, preferably 20 mol % or less, more preferably 10 mol % or less, and particularly preferably 0 mol %, based on the total number of moles of all of the raw material monomers.

The amount of the aprotic solvent (B) used in the polymerization reaction may be within the range of 20 to 300 mass %, preferably 35 to 250 mass %, and more preferably 50 to 300 mass %, based on the amount of the monomer (M) taken as 100 mass %.

The amount of the polymerization initiator used in the polymerization reaction may be, for example, within the range of 0.0001 g to 0.05 g, preferably 0.0001 g to 0.01 g, and more preferably 0.0005 g to 0.008 g, per gram of all the monomers subjected to the reaction (i.e., the total amount of the monomer (M) and other monomers).

The polymerization reaction can be performed in the presence or absence of an inert gas. However, performing the polymerization reaction in the presence of an inert gas is preferable from the standpoint of further reducing the fluoride ion content of the fluorine-containing polymer (A). The inert gas is, for example, nitrogen, argon, helium, neon, carbon dioxide, or the like, preferably nitrogen or argon, and more preferably nitrogen.

The polymerization reaction temperature can be, for example, within the range of −10° C. to 160° C., preferably 0° C. to 160° C., and more preferably 0° C. to 100° C.

The polymerization reaction can be carried out in an aprotic solvent at a temperature not exceeding a temperature that is 20° C. higher than the lower boiling point of either the monomer (M) or the aprotic solvent and not exceeding a temperature that is 20° C. higher than the 10-hour half-life temperature of the polymerization initiator, wherein the monomer (M) corresponds to the structural unit as the main component of the fluorine-containing polymer (A). In this case, the lower limit of the temperature can be, for example, −10° C., preferably 0° C.

The reaction time of the polymerization reaction may be preferably within the range of 0.5 hours to 72 hours, more preferably 1 hour to 48 hours, and even more preferably 1 hour to 30 hours

The polymerization reaction can be carried out under reduced pressure, atmospheric pressure, or elevated pressure. The polymerization reaction is preferably carried out under elevated pressure in the presence of an inert gas, from the viewpoint of further reducing the fluoride ion content in the fluorine-containing polymer (A). In this case, the pressure is preferably in the range of 0.05 to 0.2 MPa (gauge pressure).

The fluorine-containing polymer (A) produced in the polymerization reaction can be isolated or purified, if desired, by a conventional method, such as extraction, dissolution, concentration, filtration, precipitation, dehydration, adsorption, or chromatography, or a combination of these methods.

The fluorine-containing polymer (A) produced by the production method of the present disclosure has a low fluoride ion content, which is advantageous in terms of reducing waste treatment costs and reducing corrosion of equipment during subsequent purification.

The fluorine-containing polymer (A), in particular, fluorine-containing polymer (A3), usually has low solubility in aprotic solvents (B). Therefore, it was difficult to obtain a coating agent for forming a coating film of the fluorine-containing polymer (A), the coating agent containing the fluorine-containing polymer (A) at a high concentration. However, the production method of the present disclosure can produce a liquid of the fluorine-containing polymer (A) as dissolved at a high concentration in an aprotic solvent (B). For example, the production method can produce a liquid in which the fluorine-containing polymer (A) is dissolved in an amount of 20 mass % or more, preferably in the range of 20 to 65 mass %, more preferably greater than 20 mass % to 65 mass %, and particularly preferably greater than 20 mass % to 50 mass %, based on the total mass of the fluorine-containing polymer (A) and the aprotic solvent (B).

The fluorine-containing polymer (A) can be purified and isolated from this liquid. In another embodiment, the liquid may be used as is for applications that require the fluorine-containing polymer (A).

### Method for Producing Solution of Fluorine-Containing Polymer (A)

The method for producing a fluorine-containing polymer (A) solution comprises the polymerization step of polymerizing the monomer (M) in the presence of, optionally, a polymerization initiator and an aprotic solvent (B). The polymerization step is, for example, a step in which the monomer (M) is polymerized in a mixture of the monomer (M) and the aprotic solvent (B). The solution may contain fluoride ions at a concentration of 0.01 to 500 ppm by mass, preferably 0.01 to 400 ppm by mass, and more preferably 100 to 400 ppm by mass. The mixture of the monomer (M) and the aprotic solvent (B) may contain fluoride ions in a concentration of 0.05 to 300 ppm by mass, preferably 0.05 to 250 ppm by mass, and more preferably 0.05 to 150 ppm by mass.

When the fluorine-containing polymer (A) is the fluorine-containing polymer (A3), the amount of fluorine-containing polymer (A3) dissolved may be, for example, 20 mass % or more, 30 mass % or more, greater than 30 mass %, or 31 mass % or more, preferably within the range of 20 mass % to 65 mass %, greater than 20 mass % to 65 mass %, or 20 mass % to 50 mass %, more preferably within the range of 30 mass % to 65 mass %, greater than 30 mass % to 65 mass %, or 31 mass % to 65 mass %, and particularly preferably within the range of 30 mass % to 50 mass %, greater than 30 mass % to 50 mass %, or 31 mass % to 50 mass %, based on the total mass of the fluorine-containing polymer (A3) and the aprotic solvent (B).

When the fluorine-containing polymer (A) is the fluorine-containing polymer (A3), and the aprotic solvent is a non-perfluorinated solvent, the amount of fluorine-containing polymer (A3) dissolved may be less than 20 mass % in addition to the above ranges, such as 1 mass % or more, 5 mass % or more, 10 mass % or more, 15 mass % or more, 20 mass % or more, 30 mass % or more, greater than 30 mass %, or 31 mass % or more, preferably within the range of 20 mass % to 65 mass %, greater than 20 mass % to 65 mass %, or 20 mass % to 50 mass %, more preferably within the range of 30 mass % to 65 mass %, greater than 30 mass % to 65 mass %, or 31 mass % to 65 mass %, and particularly preferably within the range of 30 mass % to 50 mass %, greater than 30 mass % to 50 mass %, or 31 mass % to 50 mass %.

In the method for producing a fluorine-containing polymer (A) solution, a liquid in which the fluorine-containing polymer (A) produced by the polymerization reaction is dissolved in an aprotic solvent is obtained. In this method, for example, the monomer (M) polymerizes in an aprotic solvent, and the resulting fluorine-containing polymer (A) is obtained in a dissolved state within the polymerization reaction mixture. This method can typically be carried out in the same manner as in the method described above for producing the fluorine-containing polymer (A). Accordingly, unless otherwise specified, the above descriptions regarding the method for producing the fluorine-containing polymer (A) are applicable to the method for producing the fluorine-containing polymer (A) solution. The items described in the section on the method for producing the fluorine-containing polymer (A) are applicable to the following items used in the method for producing a fluoropolymer solution:

types and amounts of the monomer (M), polymerization initiator, aprotic solvent (B), or the like and fluoride ion concentration; various conditions of the polymerization reaction; type of the resulting fluorine-containing polymer (A), fluoride ion concentration, and dissolution concentration; etc.

### Method for Producing Mixture of Fluorine-Containing Polymer (A) and Aprotic Solvent (B)

The method for producing a mixture of the fluorine-containing polymer (A) and the aprotic solvent (B) comprises the step of mixing the fluorine-containing polymer (A) and the aprotic solvent (B).

The mixture may contain fluoride ions in a concentration of 0.01 to 500 ppm by mass, preferably 0.01 to 400 ppm by mass, and more preferably 100 to 400 ppm by mass.

The step of mixing the fluorine-containing polymer (A) and the aprotic solvent (B) may be a method in which the fluorine-containing polymer (A) in an amount equal to or greater than the amount soluble in the aprotic solvent (B) is mixed with the aprotic solvent (B). The above descriptions regarding the composition and the fluorine-containing polymer (A) are applicable to the method for producing the mixture, unless otherwise specified.

### Method for Determining Fluoride Ion Concentration

The fluoride ion concentration of the fluorine-containing polymer (A) can be determined in the following manner.

5 mL of hexafluorobenzene is added to 1 g of the polymer. The polymer is dissolved by heating at 50° C. 5 mL of pure water is added to 5 mL of the obtained solution and the resulting mixture is stirred at room temperature. The obtained aqueous phase is separated, and 4 mL of total ion strength adjustment buffer is added to 4 mL of the aqueous phase. The fluoride ion concentration of the prepared solution is measured using an ion meter. Taking the dilution ratio into account, the fluoride ion concentration is determined to be 18 times the measured value obtained.

The fluoride ion concentration in a mixture of the monomer and the solvent (a monomer solution, such as a raw-material mixture) can be determined in the following manner.

5 mL of pure water is added to 1 g of a mixture of the monomer and the solvent. The resulting mixture is stirred at room temperature, and the obtained aqueous phase is separated. 4 mL of a total ionic strength adjustment buffer is added to 4 mL of the aqueous phase. The fluoride ion concentration of the prepared solution is measured using an ion meter. Taking the dilution ratio into account, the fluoride ion concentration is determined to be 10 times the measured value obtained.

The fluoride ion concentration in the aprotic solvent (B) can also be determined in the same manner as the concentration in the mixture of the monomer and the solvent except that no monomer is used.

The fluoride ion concentration of the monomer (M) can be determined in the following manner.

A mixture of the monomer and the solvent is prepared, and the fluoride ion concentration of the mixture is determined by the method described above. Separately, the fluoride ion concentration of the solvent is determined by the method described above. The fluoride ion concentration of the solvent is subtracted from the fluoride ion concentration of the mixture of the monomer and the solvent to calculate the fluoride ion concentration of the monomer.

The fluoride ion concentration of the composition containing the fluorine-containing polymer (A) and the aprotic solvent (B) (e.g., a polymerization solution of the fluorine-containing polymer (A)) can be determined in the following manner.

3 mL of the composition is diluted by adding 3 mL of an aprotic solvent contained in the composition. 5 mL of pure water is added to 1 mL of the diluted solution and the resulting mixture is stirred at room temperature. The obtained aqueous phase is separated, and 4 mL of a total ionic strength adjustment buffer is added to 4 mL of the aqueous phase. The fluoride ion concentration of the prepared solution is measured with an ion meter. Taking the dilution ratio into account, the fluoride ion concentration is determined to be 20 times the measured value obtained.

The fluorine-containing polymer (A) produced by the production method of the present disclosure can be used for known applications of the fluorine-containing polymer (A). Since the fluorine-containing polymer (A) produced by the production method of the present disclosure has a low fluoride ion content, the fluorine-containing polymer (A) is advantageous in that it can reduce corrosion of equipment used for the fluorine-containing polymer (A) (e.g., purification systems and melt-molding equipment) and suppress contamination caused by foreign matter due to corrosion.

Although embodiments are described above, it should be understood that various modifications in form and details may be made without departing from the spirit and scope of the claims.

The present disclosure includes, for example, the following embodiments.

### Item 1.

A composition comprising a fluorine-containing polymer (A) and an aprotic solvent (B),
the composition comprising fluoride ions in an amount of 0.01 to 500 ppm by mass,
the fluorine-containing polymer (A) comprising, as a main component, a structural unit represented by formula (A1):

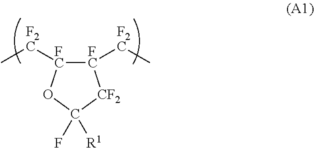

wherein R¹ represents a fluorine atom, a C₁-C₅ perfluoroalkyl group, or a C₁-C₅ perfluoroalkoxy group,
a structural unit represented by formula (A2):

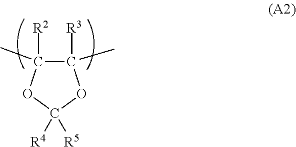

wherein R² to R⁵ each independently represent a fluorine atom, a C₁-C₅ perfluoroalkyl group, or a C₁-C₅ perfluoroalkoxy group, or a structural unit represented by formula (A3):

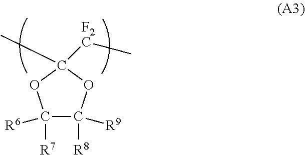

wherein R⁶ to R⁹ each independently represent a fluorine atom, a C₁-C₅ perfluoroalkyl group, or a C₁-C₅ perfluoroalkoxy group, and
the aprotic solvent (B) being at least one solvent selected from the group consisting of a perfluoroaromatic compound, a perfluorotrialkylamine, a perfluoroalkane, a hydrofluorocarbon, a fluorocyclic ether, a hydrofluoroether, and an olefin compound containing at least one chlorine atom.

### Item 2.

The composition according to Item 1, wherein the aprotic solvent (B) is at least one solvent selected from the group consisting of a perfluoroalkane, a hydrofluorocarbon, and a hydrofluoroether.

### Item 3.

The composition according to Item 1 or 2, wherein the fluorine-containing polymer (A) comprises, as the main component, a structural unit represented by any of the following formulas (A1-1) to (A3-2)

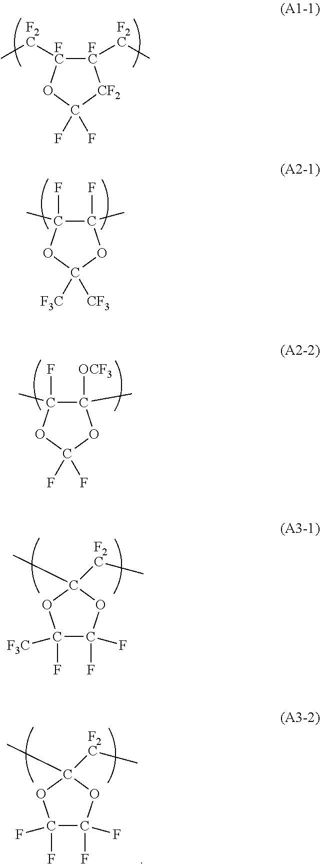

### Item 4.

The composition according to Item 3, wherein the fluorine-containing polymer (A) comprises, as the main component, a structural unit represented by formula (A3-1):

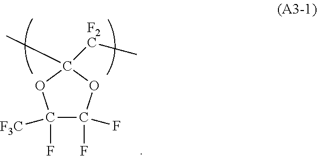

### Item 5.

The composition according to Item 1 or 2, wherein
the fluorine-containing polymer (A) comprises, as the main component, a structural unit represented by formula (A3):

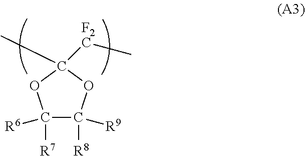

wherein R⁶ to R⁹ each independently represent a fluorine atom, a C₁-C₅ perfluoroalkyl group, or a C₁-C₅ perfluoroalkoxy group, and
the fluorine-containing polymer (A) is dissolved in the aprotic solvent (B).

### Item 6.

The composition according to Item 1 or 2, wherein
the fluorine-containing polymer (A) comprises, as the main component, a structural unit represented by formula (A3):

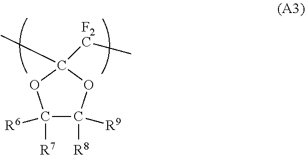

wherein R⁶ to R⁹ each independently represent a fluorine atom, a C₁-C₅ perfluoroalkyl group, or a C₁-C₅ perfluoroalkoxy group, and
the fluorine-containing polymer (A) is a solid or a semi-solid.

### Item 7.

The composition according to Item 4, further comprising a compound represented by the following formula (C):

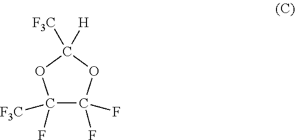 [SMILES: FC(F)(F)C1OC(F)(F)C(F)(C(F)(F)F)O1]

in an amount of 0.01 to 10 mass % based on the mass of the composition.

### Item 8.

The composition according to any one of Items 1 to 7, wherein the concentration of the fluoride ions contained in the composition is 100 to 400 ppm by mass.

### Item 9.

The composition according to any one of Items 1 to 8, wherein the aprotic solvent (B) is at least one member selected from the group consisting of CF₃CF₂CF₂CF₂OCH₃ and (CF₃)₂CFCF₂OCH₃, hexafluorobenzene, 1,1,1,3,3,3-hexafluoro-2-methoxypropane, perfluorohexane, CF₃CH₂OCF₂CHF₂, or 1,1,2,2,3,3,4-heptafluorocyclopentane.

### Item 10.

The composition according to Item 1, wherein the concentration of the fluoride ions contained in the composition is 100 to 400 ppm by mass, the fluorine-containing polymer (A) comprises, as the main component, a structural unit represented by formula (A3-1):

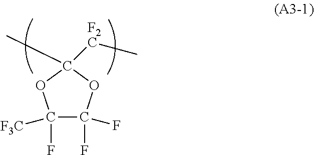

and the aprotic solvent (B) is at least one member selected from the group consisting of CF₃CF₂CF₂CF₂OCH₃ and (CF₃)₂CFCF₂OCH₃, hexafluorobenzene, 1,1,1,3,3,3-hexafluoro-2-methoxypropane, perfluorohexane, CF₃CH₂OCF₂CHF₂, or 1,1,2,2,3,3,4-heptafluorocyclopentane.

### Item 11.

A fluorine-containing polymer (A),
the fluorine-containing polymer (A) comprising fluoride ions in an amount of 0.01 to 100 ppm by mass, and
the fluorine-containing polymer (A) comprising, as a main component, a structural unit represented by formula (A1):

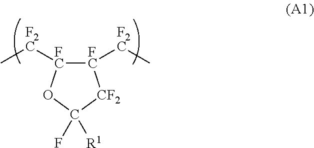

wherein R¹ represents a fluorine atom, a C₁-C₅ perfluoroalkyl group, or a C₁-C₅ perfluoroalkoxy group,
a structural unit represented by formula (A2):

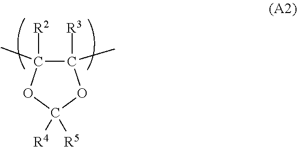

wherein R² to R⁵ each independently represent a fluorine atom, a C₁-C₅ perfluoroalkyl group, or a C₁-C₅ perfluoroalkoxy group, or a structural unit represented by formula (A3):

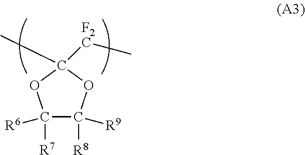

wherein R⁶ to R⁹ each independently represent a fluorine atom, a C₁-C₅ perfluoroalkyl group, or a C₁-C₅ perfluoroalkoxy group.

### Item 12.

The fluorine-containing polymer (A) according to Item 11, wherein the fluorine-containing polymer (A) comprises, as the main component, a structural unit represented by any of the following formulas (A1-1) to (A3-2):

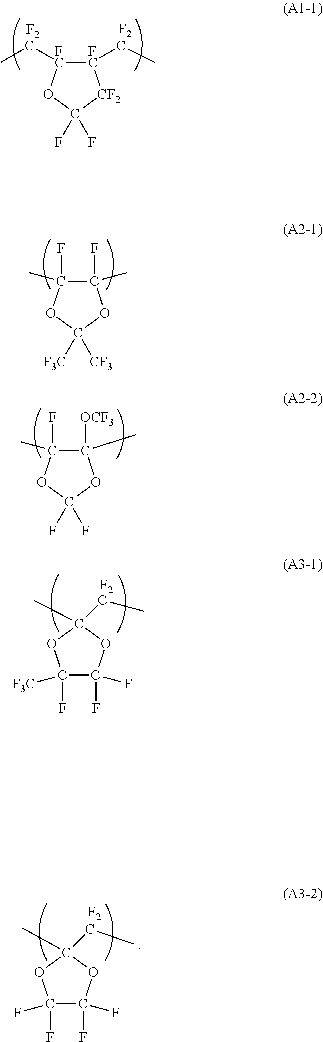

### Item 13.

The fluorine-containing polymer (A) according to Item 12, wherein the fluorine-containing polymer (A) comprises, as the main component, a structural unit represented by formula (A3-1):

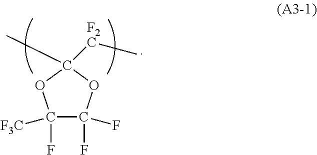

### Item 14.

The fluorine-containing polymer (A) according to any one of Items 11 to 13, wherein the fluorine-containing polymer (A) comprises fluoride ions in an amount of 10 to 80 ppm by mass.

### Item 15.

A method for producing a fluorine-containing polymer (A) solution in which a fluorine-containing polymer (A) produced by a polymerization reaction is dissolved in an aprotic solvent (B),
the method comprising a polymerization step of polymerizing a monomer (M) in a mixture of the monomer (M) and the aprotic solvent (B);
the solution comprising fluoride ions in an amount of 0.01 to 500 ppm by mass;
the mixture comprising fluoride ions in an amount of 0.05 to 300 ppm by mass;
the monomer (M) comprising a compound represented by formula (M1):

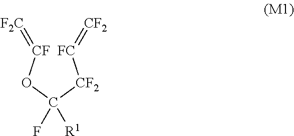

wherein R¹ represents a fluorine atom, a C₁-C₅ perfluoroalkyl group, or a C₁-C₅ perfluoroalkoxy group,
a compound represented by formula (M2):

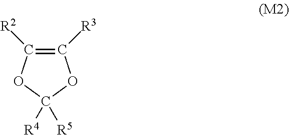

wherein R² to R⁵ each independently represent a fluorine atom, a C₁-C₅ perfluoroalkyl group, or a C₁-C₅ perfluoroalkoxy group, or
a compound represented by formula (M3):

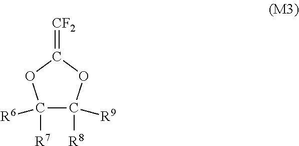

wherein R⁶ to R⁹ each independently represent a fluorine atom, a C₁-C₅ perfluoroalkyl group, or a C₁-C₅ perfluoroalkoxy group;
the fluorine-containing polymer (A) comprising, as a main component, a structural unit represented by formula (A1):

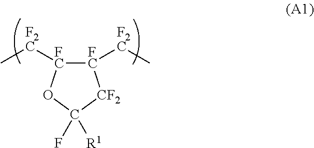

wherein R¹ represents a fluorine atom, a C₁-C₅ perfluoroalkyl group, or a C₁-C₅ perfluoroalkoxy group,
a structural unit represented by formula (A2):

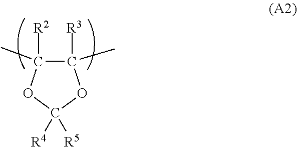

wherein R² to R⁵ each independently represent a fluorine atom, a C₁-C₅ perfluoroalkyl group, or a C₁-C₅ perfluoroalkoxy group, or
a structural unit represented by formula (A3):

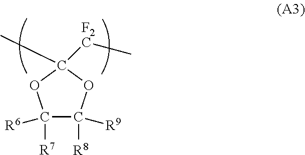

wherein R⁶ to R⁹ each independently represent a fluorine atom, a C₁-C₅ perfluoroalkyl group, or a C₁-C₅ perfluoroalkoxy group; and
the aprotic solvent (B) being at least one solvent selected from the group consisting of a perfluoroaromatic compound, a perfluorotrialkylamine, a perfluoroalkane, a hydrofluorocarbon, a fluorocyclic ether, a hydrofluoroether, and an olefin compound containing at least one chlorine atom.

### Item 16.

The method for producing a fluorine-containing polymer (A) solution according to Item 15, wherein the aprotic solvent (B) is at least one solvent selected from the group consisting of a perfluoroalkane, a hydrofluorocarbon, and a hydrofluoroether.

### Item 17.

The method for producing a fluorine-containing polymer (A) solution according to Item 15 or 16, wherein
the monomer (M) comprises a compound represented by any of the following formulas (M1-1) to (M3-2):

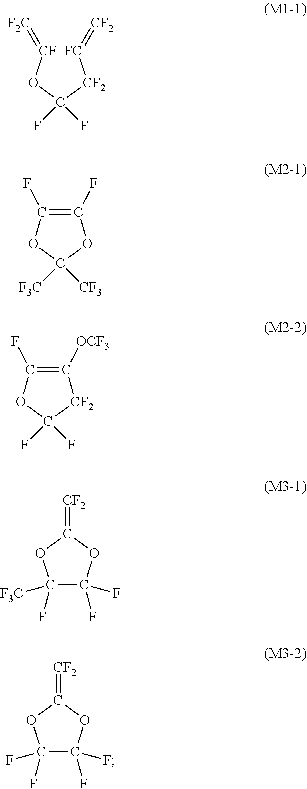

and
the fluorine-containing polymer (A) comprises, as the main component, a structural unit represented by any of the following formulas (A1-1) to (A3-2):

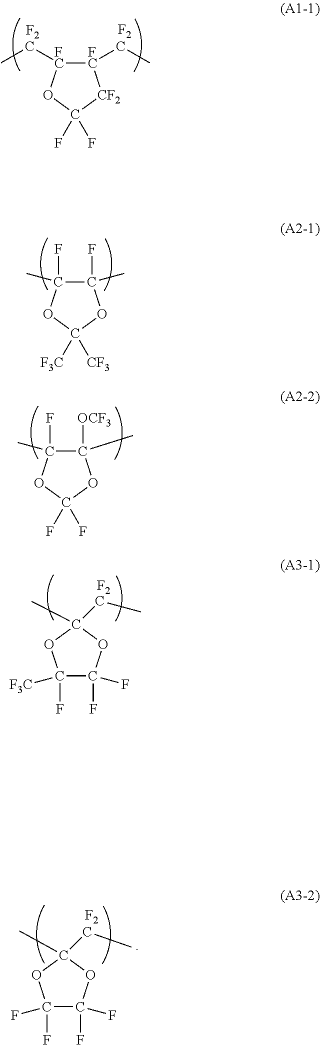

### Item 18.

The method for producing a fluorine-containing polymer (A) solution according to Item 17, wherein
the monomer (M) comprises a compound represented by formula (M3-1):

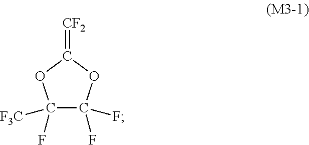

and
the fluorine-containing polymer (A) comprises, as the main component, a structural unit represented by formula (A3-1):

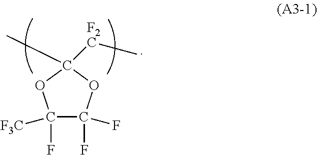

### Item 19.

The method for producing a fluorine-containing polymer (A) solution according to Item 18, wherein the fluorine-containing polymer (A) solution comprises a compound represented by formula (C):

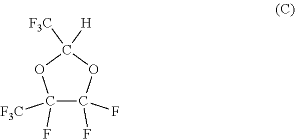 [SMILES: FC(F)(F)C1OC(F)(F)C(F)(C(F)(F)F)O1]

in an amount of 0.01 to 10 mass %.

### Item 20.

The method for producing a fluorine-containing polymer (A) solution according to any one of Items 15 to 19, wherein the aprotic solvent (B) is at least one member selected from the group consisting of CF₃CF₂CF₂CF₂OCH₃ and (CF₃)₂CFCF₂OCH₃, hexafluorobenzene, 1,1,1,3,3,3-hexafluoro-2-methoxypropane, or perfluorohexane.

### Item 21.

The method for producing a fluorine-containing polymer (A) solution according to any one of Items 15 to 20, wherein the solution comprises fluoride ions in an amount of 100 to 400 ppm by mass, and the mixture comprises fluoride ions in an amount of 0.05 to 150 ppm by mass.

### Item 22.

The method for producing a fluorine-containing polymer (A) solution according to Item 15, wherein
the solution comprises fluoride ions in an amount of 100 to 400 ppm by mass;
the mixture comprises fluoride ions in an amount of 0.05 to 150 ppm by mass;
the monomer (M) comprises a compound represented by formula (M3-1):

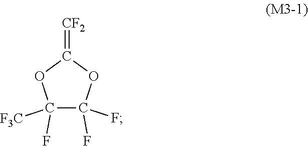

the fluorine-containing polymer (A) comprises, as the main component, a structural unit represented by formula (A3-1):

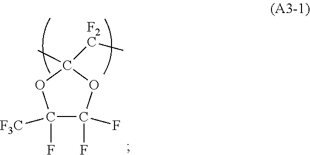

and
from the group consisting of CF₃CF₂CF₂CF₂OCH₃ and (CF₃)₂CFCF₂OCH₃, hexafluorobenzene, 1,1,1,3,3,3-hexafluoro-2-methoxypropane, or perfluorohexane.

### Item 23.

A method for producing a mixture of a fluorine-containing polymer (A) and an aprotic solvent (B),
the method comprising mixing the fluorine-containing polymer (A) and the aprotic solvent (B),
the mixture comprising fluoride ions in an amount of 0.01 to 500 ppm by mass,
the fluorine-containing polymer (A) comprising, as a main component, a structural unit represented by formula (A1):

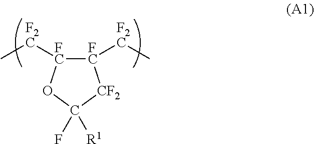

wherein R¹ represents a fluorine atom, a C₁-C₅ perfluoroalkyl group, or a C₁-C₅ perfluoroalkoxy group,
a structural unit represented by formula (A2):

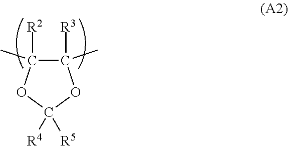

wherein R² to R⁵ each independently represent a fluorine atom, a C₁-C₅ perfluoroalkyl group, or a C₁-C₅ perfluoroalkoxy group, or
a structural unit represented by formula (A3):

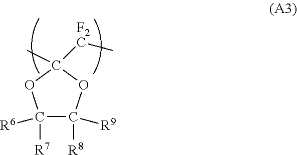

wherein R⁶ to R⁹ each independently represent a fluorine atom, a C₁-C₅ perfluoroalkyl group, or a C₁-C₅ perfluoroalkoxy group, and
the aprotic solvent (B) being at least one solvent selected from the group consisting of a perfluoroaromatic compound, a perfluorotrialkylamine, a perfluoroalkane, a hydrofluorocarbon, a fluorocyclic ether, a hydrofluoroether, and an olefin compound containing at least one chlorine atom.

### Item 24.

The method for producing a mixture of a fluorine-containing polymer (A) and an aprotic solvent (B) according to Item 23, wherein the aprotic solvent (B) is at least one solvent selected from the group consisting of a perfluoroalkane, a hydrofluorocarbon, and a hydrofluoroether.

### Item 25.

The method for producing a mixture of a fluorine-containing polymer (A) and an aprotic solvent (B) according to Item 23 or 24, wherein the fluorine-containing polymer (A) comprises, as the main component, a structural unit represented by any of the following formulas (A1-1) to (A3-2):

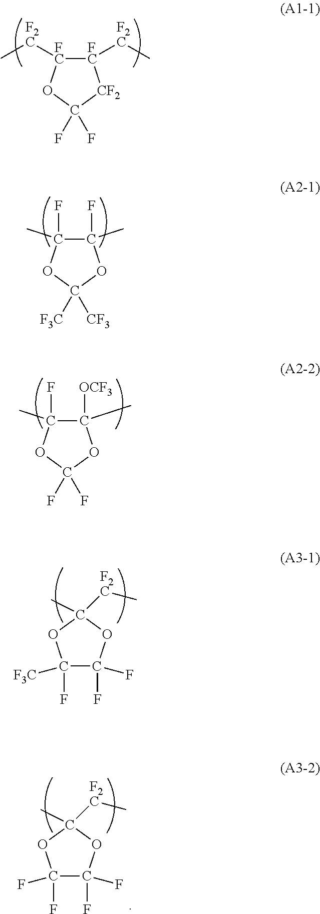

### Item 26.

The method for producing a mixture of a fluorine-containing polymer (A) and an aprotic solvent (B) according to Item 25, wherein the fluorine-containing polymer (A) comprises, as the main component, a structural unit represented by formula (A3-1):

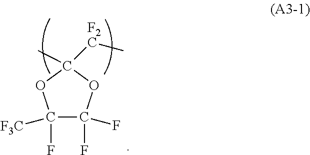

### Item 27.

The method for producing a mixture of a fluorine-containing polymer (A) and an aprotic solvent (B) according to Item 23 or 24, wherein the fluorine-containing polymer (A) in the mixture of the fluorine-containing polymer (A) and the aprotic solvent (B) comprises, as the main component, the structural unit represented by formula (A3) and is a solid or a semi-solid.

### Item 28.

A method for producing a fluorine-containing polymer (A),
the method comprising a polymerization step of polymerizing a monomer (M) in a mixture of the monomer (M) and an aprotic solvent (B),
the fluorine-containing polymer (A) comprising fluoride ions in an amount of 0.01 to 100 ppm by mass, the mixture comprising fluoride ions in an amount of 0.05 to 300 ppm by mass,
the monomer (M) comprising a compound represented by formula (M1):

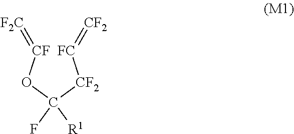

wherein R¹ represents a fluorine atom, a C₁-C₅ perfluoroalkyl group, or a C₁-C₅ perfluoroalkoxy group,
a compound represented by formula (M2):

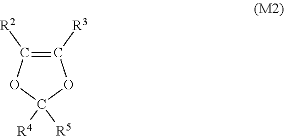

wherein R² to R⁵ each independently represent a fluorine atom, a C₁-C₅ perfluoroalkyl group, or a C₁-C₅ perfluoroalkoxy group, or
a compound represented by formula (M3):

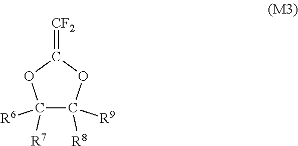

wherein R⁶ to R⁹ each independently represent a fluorine atom, a C₁-C₅ perfluoroalkyl group, or a C₁-C₅ perfluoroalkoxy group,
the fluorine-containing polymer (A) comprising, as a main component, a structural unit represented by formula (A1):

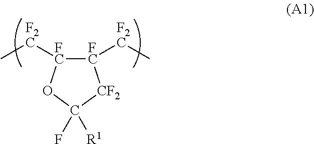

wherein R¹ represents a fluorine atom, a C₁-C₅ perfluoroalkyl group, or a C₁-C₅ perfluoroalkoxy group,
a structural unit represented by formula (A2):

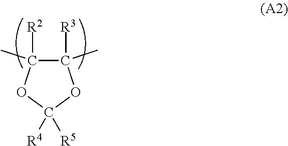

wherein R² to R⁵ each independently represent a fluorine atom, a C₁-C₅ perfluoroalkyl group, or a C₁-C₅ perfluoroalkoxy group, or
a structural unit represented by formula (A3):

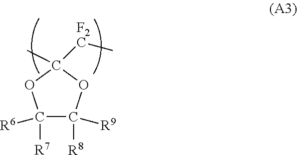

wherein R⁶ to R⁹ each independently represent a fluorine atom, a C₁-C₅ perfluoroalkyl group, or a C₁-C₅ perfluoroalkoxy group, and
the aprotic solvent (B) being at least one solvent selected from the group consisting of a perfluoroaromatic compound, a perfluorotrialkylamine, a perfluoroalkane, a hydrofluorocarbon, a fluorocyclic ether, a hydrofluoroether, and an olefin compound containing at least one chlorine atom.

### Item 29.

The method for producing a fluorine-containing polymer (A) according to Item 28, wherein the aprotic solvent (B) is at least one solvent selected from the group consisting of a perfluoroalkane, a hydrofluorocarbon, and a hydrofluoroether.

### Item 30.

The method for producing a fluorine-containing polymer (A) according to Item 28 or 29, wherein
the monomer (M) comprises a compound represented by any of the following formulas (M1-1) to (M3-2):

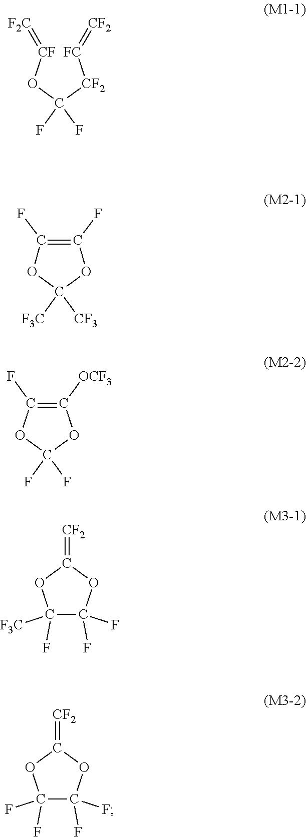

and
the fluorine-containing polymer (A) comprises, as the main component, a structural unit represented by any of the following formulas (A1-1) to (A3-2):

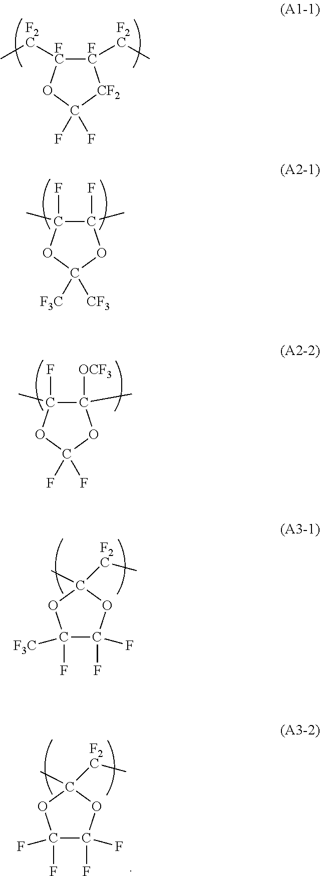

### Item 31.

The method for producing a fluorine-containing polymer (A) according to Item 30, wherein
the monomer (M) comprises a compound represented by formula (M3-1):

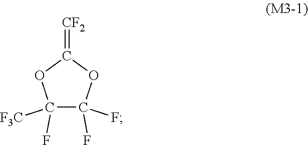

and
the fluorine-containing polymer (A) comprises, as the main component, a structural unit represented by formula (A3-1):

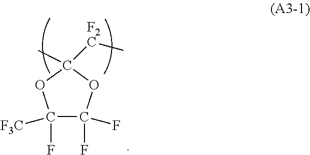

### Item 32.

The method for producing a fluorine-containing polymer (A) according to Item 31, wherein the monomer (M) comprises a compound represented by formula (C):

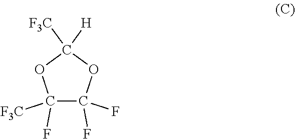 [SMILES: FC(F)(F)C1OC(F)(F)C(F)(C(F)(F)F)O1]

in an amount of 0.01 to 10 mass %.

### Item 33.

The method for producing a fluorine-containing polymer (A) according to Item 28 or 29, wherein in the polymerization step, the fluorine-containing polymer (A) produced by a polymerization reaction comprises, as the main component, the structural unit represented by formula (A3) and is dissolved in the aprotic solvent (B), or the fluorine-containing polymer (A) produced by a polymerization reaction is a solid or a semi-solid in the aprotic solvent (B).

### Item 34.

The method for producing a fluorine-containing polymer (A) according to any one of Items 28 to 33, wherein the fluorine-containing polymer (A) comprises fluoride ions in an amount of 10 to 80 ppm by mass, and the mixture comprises fluoride ions in an amount of 0.05 to 150 ppm by mass.

### Item 35.

The method for producing a fluorine-containing polymer (A) according to Item 28, wherein
the fluorine-containing polymer (A) comprises fluoride ions in an amount of 10 to 80 ppm by mass;
the mixture comprises fluoride ions in an amount of 0.05 to 150 ppm by mass;
the monomer (M) comprises a compound represented by formula (M3-1):

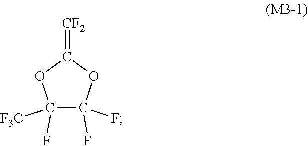

and
the fluorine-containing polymer (A) comprises, as the main component, a structural unit represented by formula (A3-1):

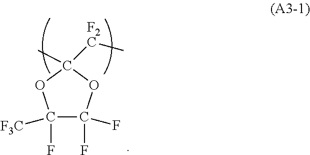

### EXAMPLES

Embodiments of the present disclosure are described in more detail below with reference to Examples. However, the present disclosure is not limited to these.

The following are the fluorine-containing monomer etc. used in the Examples below.

### Raw Material Monomer

Perfluoro(2-methylene-4-methyl-1,3-dioxolane) (Monomer (M3-1))

### Polymerization Initiator

PFBPO (bis(2,3,4,5,6-pentafluorobenzoyl)peroxide)

### Polymerization Initiator Solution

Polymerization initiator solution (1): a methanol solution containing 50 mass % of NPP (di-n-propyl peroxydicarbonate, 10-hour half-life temperature: 40° C.)

### Aprotic Solvents

Novec 7100: a mixture of CF₃CF₂CF₂OCH₂ and (CF₃)₂CFCF₂OCH₃ (3M Japan Limited)
Hexafluorobenzene
HFMPP: 1,1,1,3,3,3-hexafluoro-2-methoxypropane (Daikin Industries, Ltd.)
FC-72: Perfluorohexane (3M Japan Limited)
AE-3000: CF₃CH₂OCF₂CHF₂ (AGC Inc.)
Zeorora H: 1,1,2,2,3,3,4-heptafluorocyclopentane (Zeon Corporation)

### Method for Measuring Fluoride Ion Concentration in Mixture of Monomer and Solvent (Monomer Solution)

5 mL of pure water was added to 1 g of a mixture of a monomer and a solvent, and the resulting mixture was stirred at room temperature. The resulting aqueous phase was separated, and 4 mL of total ionic strength adjustment buffer was added to 4 mL of the aqueous phase. The concentration of fluoride ions in the prepared solution was measured using an ion meter. Taking the dilution ratio into account, the fluoride ion concentration was determined to be 10 times the measured value obtained.

### Method for Measuring Fluoride Ion Concentration of the Polymer

5 mL of hexafluorobenzene was added to 1 g of the polymer. The polymer was dissolved by heating at 50° C. 5 mL of pure water was added to 5 mL of the obtained solution, and the resulting mixture was stirred at room temperature. The resulting aqueous phase was separated, and 4 mL of total ionic strength adjustment buffer was added to 4 mL of the aqueous phase. The fluoride ion concentration of the prepared solution was measured with an ion meter. Taking the dilution ratio into account, the fluoride ion concentration was determined to be 18 times the measured value obtained.

### Method for Measuring Fluoride Ion Concentration in the Polymerization Reaction Mixture

3 mL of the reaction mixture after the polymerization reaction was diluted by adding an equal volume of a polymerization solvent. In the case of solution polymerization, a reaction mixture in which the polymer obtained by the polymerization reaction was dissolved in the solvent (a composition containing the polymer and the solvent) was used as the reaction mixture to be diluted. In the case of precipitation polymerization, the polymerization reaction mixture in a mixture of the solid polymer obtained by the polymerization reaction and the polymerization reaction mixture (a composition containing the polymer and the solvent) was used as the reaction mixture to be diluted. 5 mL of pure water was added to 1 mL of the dilution solution and the resulting mixture was stirred at room temperature. The resulting aqueous phase was separated, and 4 mL of total ionic strength adjustment buffer was added to 4 mL of the aqueous phase. The fluoride ion concentration of the prepared solution was measured with an ion meter. Taking the dilution ratio into account, the fluoride ion concentration was determined to be 20 times the measured value obtained.

### Investigation of Presence or Absence of Corrosion in the Stainless Steel Container Used for the Polymerization Reaction

Samples in which the inner surface of the container turned black or gold after the polymerization reaction were judged as being corroded.

### Production Example 1: Treatment for Reducing Fluoride Ion Concentration in Monomer (M3-1) Solution

50 g of a monomer (M3-1) was added to 100 g of Novec 7100 and the resulting mixture was stirred. The fluoride ion concentration in the obtained monomer solution was 1500 ppm by mass. The monomer solution was treated with 15 g of activated carbon to obtain a monomer solution with a fluoride ion concentration of 110 ppm by mass. The monomer solution was analyzed by gas chromatography and the analysis results show that the compound (C) was present at 3.6% relative to the monomer (based on GC area percentage).

### Example 1: Solution Polymerization

100 g of the monomer (M3-1) solution obtained in Production Example 1 was placed in a 300-mL SUS autoclave. Subsequently, 0.1 g of polymerization initiator solution (1) was added. After the autoclave was cooled to −78° C., the atmosphere in the system was replaced with nitrogen gas, and the system was filled with nitrogen gas so that the internal pressure was 0.1 MPaG. The polymerization reaction was allowed to proceed at 40° C. for 24 hours to obtain a polymer solution in which the produced polymer was dissolved (a composition containing the fluorine-containing polymer (A) and an aprotic solvent (B)). The polymer ion concentration of the polymer solution was measured. Table 1 shows the results.

100 g of AE-3000 was added to the polymer solution, and dimethyl carbonate, which is a poor solvent, was added dropwise. The resulting precipitate was collected by filtration and dried at 120° C. to obtain a polymer.

The fluoride ion concentration of the polymer was measured. Table 1 shows the results.

The inside of the autoclave after polymerization was visually inspected. No change in color of the material to black or gold was observed.

### Examples 2 to 4: Solution Polymerization

The fluoride ion concentration and the presence or absence of corrosion in the polymerization container were evaluated in the same manner as in Example 1 except that the solvent was changed to one listed in Table 1 (hexafluorobenzene, HFMOP, or FC-72). Table 1 shows the results.

### Comparative Example 1: Solution Polymerization

The fluoride ion concentration and the presence or absence of corrosion in the polymerization vessel were evaluated in the same manner as in Example 1 except that the monomer solution was changed to one before being subjected to the fluoride ion concentration reduction treatment (fluoride ion concentration: 1500 ppm). Table 1 shows the results. The inside of the autoclave after polymerization was visually inspected. The material of the inside of the autoclave was observed to have turned gold in color.

### Example 5: Precipitation Polymerization

A solution of monomer (M3-1) was obtained in the same manner as in Production Example 1 except that the solvent was changed from Novec 7100 to AE-3000. 100 g of this monomer (M3-1) solution was placed into a 300-mL SUS autoclave and 0.1 g of a polymerization initiator solution (1) was added. After cooling the autoclave to −78° C., the atmosphere in the system was replaced with nitrogen gas, and the system was filled with nitrogen gas to achieve an internal pressure of 0.1 MPaG. A polymerization reaction was carried out at 40° C. for 24 hours to obtain a polymer mixture in which the obtained polymer precipitated (a composition containing the polymer (A) and an aprotic solvent (B)). The fluoride ion concentration in the polymerization reaction solution in the polymer mixture was measured. Table 1 shows the results.

The polymer mixture was collected by filtration and dried at 120° C. to obtain a solid polymer.

The polymer ion concentration of the polymer was measured. Table 1 shows the results.

The inside of the autoclave after polymerization was visually inspected. No change in color of the material to black or gold was observed.

### Example 6: Precipitation Polymerization

The fluoride ion concentration and corrosion of the polymerization vessel were evaluated in the same manner as in Example 5 except that the solvent was changed to Zeorora H. Table 1 shows the results.

### Comparative Example 2: Precipitation Polymerization

The fluoride ion concentration and the presence or absence of corrosion of the polymerization vessel were evaluated in the same manner as in Example 5 except that the monomer solution was changed to one before being subjected to the fluoride ion concentration reduction treatment (fluoride ion concentration: 1500 ppm) and that the polymerization initiator solution (1) was changed to a polymerization initiator (PFBPO; 0.1 g). Table 1 shows the results. The inside of the autoclave after polymerization was visually inspected. The material of the inside of the autoclave was observed to have turned gold in color.

| | Amount of | | | | Amount of | | |
|---|---|---|---|---|---|---|---|
| | fluoride ions | | | | fluoride ions in | | |
| | in the | | | | the | | Amount of |
| | monomer | | | | polymerization | Corrosion of | fluoride ions in |
| | solution (ppm | Polymerization | | | solution | polymerization | the polymer |
| | by mass) | initiator | Solvent | Polymerization | (ppm by mass) | vessels | (ppm by mass) |
| Example 1 | 110 | NPP | Novec 7100 | Solution | 149 | No | 24 |
| | | | | polymerization | | | |
| Example 2 | 110 | NPP | Hexafluorobenzene | Solution | 361 | No | 74 |
| | | | | polymerization | | | |
| Example 3 | 110 | NPP | HFMOP | Solution | 318 | No | 35 |
| | | | | polymerization | | | |
| Example 4 | 110 | NPP | FC-72 | Solution | 244 | No | 60 |
| | | | | polymerization | | | |
| Example 5 | 110 | NPP | AE-3000 | Precipitation | 166 | No | 38 |
| | | | | polymerization | | | |
| Example 6 | 110 | NPP | Zeorora H | Precipitation | 305 | No | 71 |
| | | | | polymerization | | | |
| Comp. Ex. 1 | 1,500 | NPP | Novec 7100 | Solution | 1,544 | Yes | 210 |
| | | | | polymerization | | | |
| Comp. Ex. 2 | 1,500 | PFBPO | AE-3000 | Precipitation | 2,520 | Yes | 380 |
| | | | | polymerization | | | |

1. A composition comprising a fluorine-containing polymer (A) and an aprotic solvent (B),
the composition comprising fluoride ions in an amount of 0.01 to 500 ppm by mass,
the fluorine-containing polymer (A) comprising, as a main component, a structural unit represented by formula (A1): 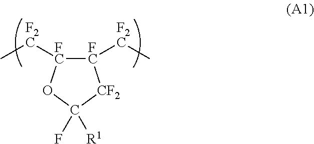
wherein R¹ represents a fluorine atom, a C₁-C₅ perfluoroalkyl group, or a C₁-C₅ perfluoroalkoxy group,
a structural unit represented by formula (A2): 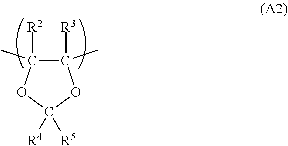
wherein R² to R⁵ each independently represent a fluorine atom, a C₁-C₅ perfluoroalkyl group, or a C₁-C₅ perfluoroalkoxy group, or
a structural unit represented by formula (A3): 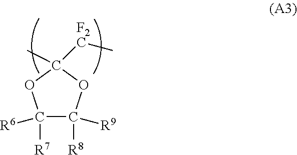
wherein R⁶ to R⁹ each independently represent a fluorine atom, a C₁-C₅ perfluoroalkyl group, or a C₁-C₅ perfluoroalkoxy group, and
the aprotic solvent (B) being at least one solvent selected from the group consisting of a perfluoroaromatic compound, a perfluorotrialkylamine, a perfluoroalkane, a hydrofluorocarbon, a fluorocyclic ether, a hydrofluoroether, and an olefin compound containing at least one chlorine atom.

2. The composition according to claim 1, wherein the aprotic solvent (B) is at least one solvent selected from the group consisting of a perfluoroalkane, a hydrofluorocarbon, and a hydrofluoroether.

3. (canceled)

4. The composition according to claim 1, wherein the fluorine-containing polymer (A) comprises, as the main component, a structural unit represented by formula (A3-1):

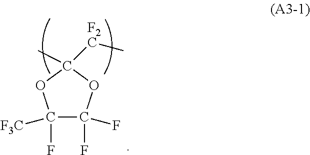

5. The composition according to claim 1, wherein
the fluorine-containing polymer (A) comprises, as the main component, a structural unit represented by formula (A3): 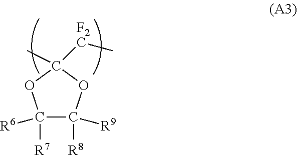
wherein R⁶ to R⁹ each independently represent a fluorine atom, a C₁-C₅ perfluoroalkyl group, or a C₁-C₅ perfluoroalkoxy group, and
the fluorine-containing polymer (A) is dissolved in the aprotic solvent (B).

6. The composition according to claim 1, wherein
the fluorine-containing polymer (A) comprises, as the main component, a structural unit represented by formula (A3): 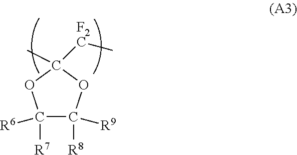
wherein R⁶ to R⁹ each independently represent a fluorine atom, a C₁-C₅ perfluoroalkyl group, or a C₁-C₅ perfluoroalkoxy group, and
the fluorine-containing polymer (A) is a solid or a semi-solid.

7. The composition according to claim 4, further comprising a compound represented by the following formula (C): 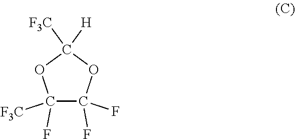 [SMILES: FC(F)(F)C1OC(F)(F)C(F)(C(F)(F)F)O1]
in an amount of 0.01 to 10 mass % based on the mass of the composition.

8-9. (canceled)

10. The composition according to claim 1, wherein the concentration of the fluoride ions contained in the composition is 100 to 400 ppm by mass, the fluorine-containing polymer (A) comprises, as the main component, a structural unit represented by formula (A3-1): 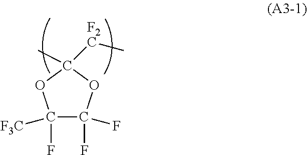
and the aprotic solvent (B) is at least one member selected from the group consisting of CF₃CF₂CF₂CF₂OCH₃ and (CF₃)₂CFCF₂OCH₃, hexafluorobenzene, 1,1,1,3,3,3-hexafluoro-2-methoxypropane, perfluorohexane, CF₃CH₂OCF₂CHF₂, or 1,1,2,2,3,3,4-heptafluorocyclopentane.

11. A fluorine-containing polymer (A),
the fluorine-containing polymer (A) comprising fluoride ions in an amount of 0.01 to 100 ppm by mass, and
the fluorine-containing polymer (A) comprising, as a main component, a structural unit represented by formula (A1): 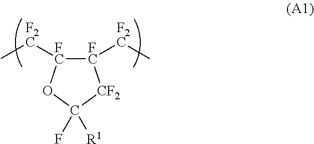
wherein R¹ represents a fluorine atom, a C₁-C₅ perfluoroalkyl group, or a C₁-C₅ perfluoroalkoxy group,
a structural unit represented by formula (A2): 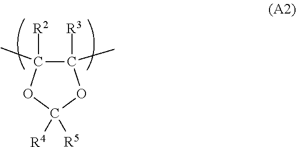
wherein R² to R⁵ each independently represent a fluorine atom, a C₁-C₅ perfluoroalkyl group, or a C₁-C₅ perfluoroalkoxy group, or
a structural unit represented by formula (A3): 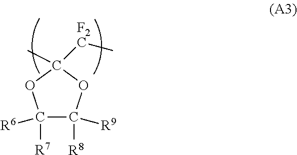
wherein R⁶ to R⁹ each independently represent a fluorine atom, a C₁-C₅ perfluoroalkyl group, or a C₁-C₅ perfluoroalkoxy group.

12. (canceled)

13. The fluorine-containing polymer (A) according to claim 11, wherein the fluorine-containing polymer (A) comprises, as the main component, a structural unit represented by formula (A3-1):

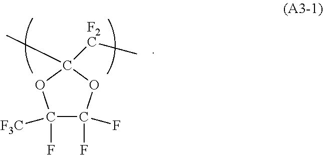

14. (canceled)

15. A method for producing a fluorine-containing polymer (A) solution in which a fluorine-containing polymer (A) produced by a polymerization reaction is dissolved in an aprotic solvent (B),
the method comprising a polymerization step of polymerizing a monomer (M) in a mixture of the monomer (M) and the aprotic solvent (B);
the solution comprising fluoride ions in an amount of 0.01 to 500 ppm by mass;
the mixture comprising fluoride ions in an amount of 0.05 to 300 ppm by mass;
the monomer (M) comprising a compound represented by formula (M1): 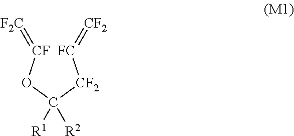
wherein R¹ represents a fluorine atom, a C₁-C₅ perfluoroalkyl group, or a C₁-C₅ perfluoroalkoxy group,
a compound represented by formula (M2): 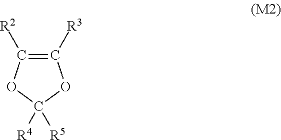
wherein R² to R⁵ each independently represent a fluorine atom, a C₁-C₅ perfluoroalkyl group, or a C₁-C₅ perfluoroalkoxy group, or
a compound represented by formula (M3): 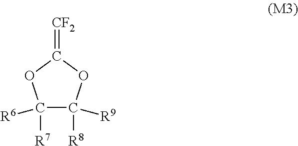
wherein R⁶ to R⁹ each independently represent a fluorine atom, a C₁-C₅ perfluoroalkyl group, or a C₁-C₅ perfluoroalkoxy group;
the fluorine-containing polymer (A) comprising, as a main component, a structural unit represented b formula (A1): 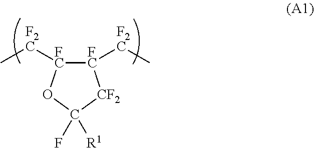
wherein R¹ represents a fluorine atom, a C₁-C₅ perfluoroalkyl group, or a C₁-C₅ perfluoroalkoxy group,
a structural unit represented by formula (A2): 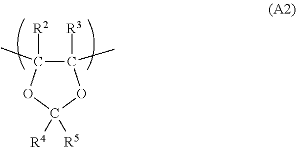
wherein R² to R⁵ each independently represent a fluorine atom, a C₁-C₅ perfluoroalkyl group, or a C₁-C₅ perfluoroalkoxy group, or
a structural unit represented by formula (A3): 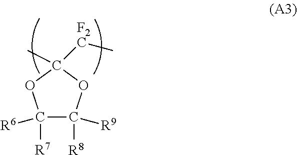
wherein R⁶ to R⁹ each independently represent a fluorine atom, a C₁-C₅ perfluoroalkyl group, or a C₁-C₅ perfluoroalkoxy group; and
the aprotic solvent (B) being at least one solvent selected from the group consisting of a perfluoroaromatic compound, a perfluorotrialkylamine, a perfluoroalkane, a hydrofluorocarbon, a fluorocyclic ether, a hydrofluoroether, and an olefin compound containing at least one chlorine atom.

16. The method for producing a fluorine-containing polymer (A) solution according to claim 15, wherein the aprotic solvent (B) is at least one solvent selected from the group consisting of a perfluoroalkane, a hydrofluorocarbon, and a hydrofluoroether.

17. (canceled)

18. The method for producing a fluorine-containing polymer (A) solution according to claim 15, wherein
the monomer (M) comprises a compound represented by formula (M3-1): 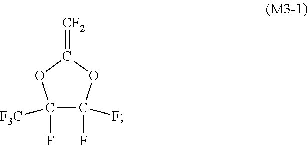
and
the fluorine-containing polymer (A) comprises, as the main component, a structural unit represented by formula (A3-1):

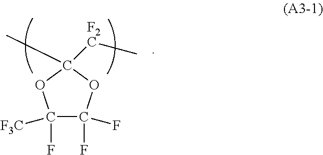

19. The method for producing a fluorine-containing polymer (A) solution according to claim 18, wherein the fluorine-containing polymer (A) solution comprises a compound represented by formula (C): 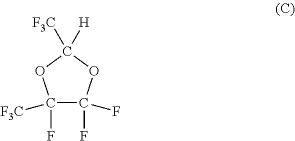 [SMILES: FC(F)(F)C1OC(F)(F)C(F)(C(F)(F)F)O1]
in an amount of 0.01 to 10 mass %.

20-21. (canceled)

22. The method for producing a fluorine-containing polymer (A) solution according to claim 15, wherein
the solution comprises fluoride ions in an amount of 100 to 400 ppm by mass;
the mixture comprises fluoride ions in an amount of 0.05 to 150 ppm by mass;
the monomer (M) comprises a compound represented by formula (M3-1): 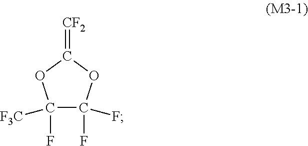
the fluorine-containing polymer (A) comprises, as the main component, a structural unit represented by formula (A3-1): 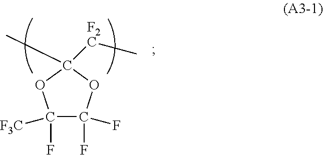
and
the aprotic solvent (B) is at least one member selected from the group consisting of CF₃CF₂CF₂CF₂OCH₃ and (CF₃)₂CFCF₂OCH₃, hexafluorobenzene, 1,1,1,3,3,3-hexafluoro-2-methoxypropane, or perfluorohexane.

23. A method for producing a mixture of a fluorine-containing polymer (A) and an aprotic solvent (B),
the method comprising mixing the fluorine-containing polymer (A) and the aprotic solvent (B),
the mixture comprising fluoride ions in an amount of 0.01 to 500 ppm by mass,
the fluorine-containing polymer (A) comprising, as a main component, a structural unit represented by formula (A1): 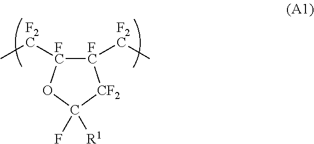
wherein R¹ represents a fluorine atom, a C₁-C₅ perfluoroalkyl group, or a C₁-C₅ perfluoroalkoxy group,
a structural unit represented by formula (A2): 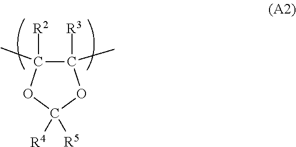
wherein R² to R⁵ each independently represent a fluorine atom, a C₁-C₅ perfluoroalkyl group, or a C₁-C₅ perfluoroalkoxy group, or
a structural unit represented by formula (A3): 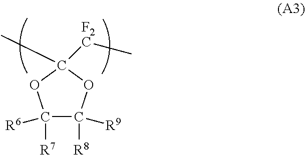
wherein R⁶ to R⁹ each independently represent a fluorine atom, a C₁-C₅ perfluoroalkyl group, or a C₁-C₅ perfluoroalkoxy group, and
the aprotic solvent (B) being at least one solvent selected from the group consisting of a perfluoroaromatic compound, a perfluorotrialkylamine, a perfluoroalkane, a hydrofluorocarbon, a fluorocyclic ether, a hydrofluoroether, and an olefin compound containing at least one chlorine atom.

24-25. (canceled)

26. The method for producing a mixture of a fluorine-containing polymer (A) and an aprotic solvent (B) according to claim 23, wherein the fluorine-containing polymer (A) comprises, as the main component, a structural unit represented by formula (A3-1):

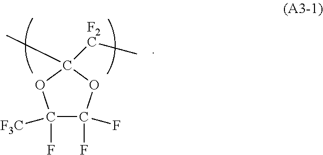

27. The method for producing a mixture of a fluorine-containing polymer (A) and an aprotic solvent (B) according to claim 23, wherein the fluorine-containing polymer (A) in the mixture of the fluorine-containing polymer (A) and the aprotic solvent (B) comprises, as the main component, the structural unit represented by formula (A3) and is a solid or a semi-solid.

28. A method for producing a fluorine-containing polymer (A) according to claim 11,
the method comprising a polymerization step of polymerizing a monomer (M) in a mixture of the monomer (M) and an aprotic solvent (B),
the fluorine-containing polymer (A) comprising fluoride ions in an amount of 0.01 to 100 ppm by mass,
the mixture comprising fluoride ions in an amount of 0.05 to 300 ppm by mass,
the monomer (M) comprising a compound represented by formula (M1): 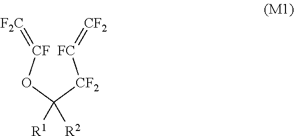
wherein R¹ represents a fluorine atom, a C₁-C₅ perfluoroalkyl group, or a C₁-C₅ perfluoroalkoxy group,
a compound represented by formula (M2): 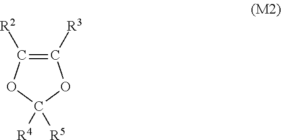
wherein R² to R⁵ each independently represent a fluorine atom, a C₁-C₅ perfluoroalkyl group, or a C₁-C₅ perfluoroalkoxy group, or
a compound represented by formula (M3): 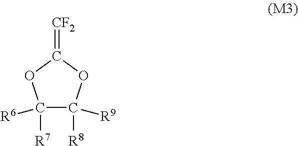
wherein R⁶ to R⁹ each independently represent a fluorine atom, a C₁-C₅ perfluoroalkyl group, or a C₁-C₅ perfluoroalkoxy group,
the fluorine-containing polymer (A) comprising, as a main component, a structural unit represented by formula (A1): 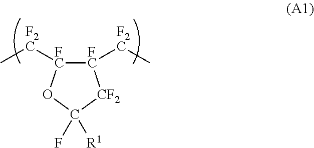
wherein R¹ represents a fluorine atom, a C₁-C₅ perfluoroalkyl group, or a C₁-C₅ perfluoroalkoxy group,
a structural unit represented by formula (A2): 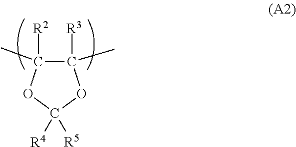
wherein R² to R⁵ each independently represent a fluorine atom, a C₁-C₅ perfluoroalkyl group, or a C₁-C₅ perfluoroalkoxy group, or
a structural unit represented by formula (A3): 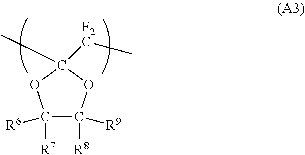
wherein R⁶ to R⁹ each independently represent a fluorine atom, a C₁-C₅ perfluoroalkyl group, or a C₁-C₅ perfluoroalkoxy group, and
the aprotic solvent (B) being at least one solvent selected from the group consisting of a perfluoroaromatic compound, a perfluorotrialkylamine, a perfluoroalkane, a hydrofluorocarbon, a fluorocyclic ether, a hydrofluoroether, and an olefin compound containing at least one chlorine atom.

29. The method for producing a fluorine-containing polymer (A) according to claim 28, wherein the aprotic solvent (B) is at least one solvent selected from the group consisting of a perfluoroalkane, a hydrofluorocarbon, and a hydrofluoroether.

30. (canceled)

31. The method for producing a fluorine-containing polymer (A) according to claim 30, wherein
the monomer (M) comprises a compound represented by formula (M3-1): 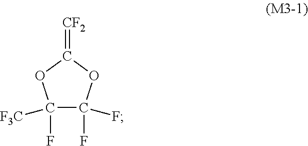
and
the fluorine-containing polymer (A) comprises, as the main component, a structural unit represented by formula (A3-1):

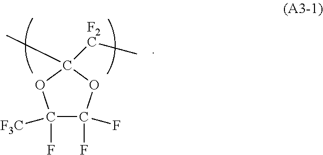

32. The method for producing a fluorine-containing polymer (A) according to claim 31, wherein the monomer (M) comprises a compound represented by formula (C): 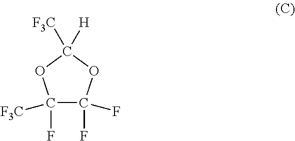 [SMILES: FC(F)(F)C1OC(F)(F)C(F)(C(F)(F)F)O1]
in an amount of 0.01 to 10 mass %.

33. The method for producing a fluorine-containing polymer (A) according to claim 28, wherein in the polymerization step, the fluorine-containing polymer (A) produced by a polymerization reaction comprises, as the main component, the structural unit represented by formula (A3) and is dissolved in the aprotic solvent (B), or the fluorine-containing polymer (A) produced by a polymerization reaction is a solid or a semi-solid in the aprotic solvent (B).

34. (canceled)

35. The method for producing a fluorine-containing polymer (A) according to claim 28, wherein
the fluorine-containing polymer (A) comprises fluoride ions in an amount of 10 to 80 ppm by mass;
the mixture comprises fluoride ions in an amount of 0.05 to 150 ppm by mass;
the monomer (M) comprises a compound represented by formula (M3-1): 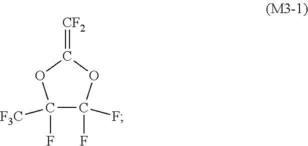
and
the fluorine-containing polymer (A) comprises, as the main component, a structural unit represented by formula (A3-1): [chemical structure]
